(19) United States
(12) Patent Application Publication
(10) Pub. No.: US 2023/0155836 A1
(43) Pub. Date: May 18, 2023

(54) SECURE SERVERLESS MULTI-FACTOR AUTHENTICATION

(71) Applicant: Architecture Technology Corporation, Minneapolis, MN (US)

(72) Inventors: Benjamin L. Burnett, Prior Lake, MN (US); Jafar Al-Gharaibeh, Eden Prairie, MN (US)

(21) Appl. No.: 17/931,407

(22) Filed: Sep. 12, 2022

Related U.S. Application Data
(60) Provisional application No. 63/278,866, filed on Nov. 12, 2021.

(51) Int. Cl. H04L 9/32; H04L 9/06

(52) U.S. Cl. CPC H04L 9/3236; H04L 9/3231; H04L 9/0643

(57) ABSTRACT

In general, the techniques of this disclosure describe a system for secure serverless authentication. An authenticator node of the system may receive indications of values of authentication factors associated with an entity. The authenticator node may hash the values of the authentication factors to generate double hashed values of the authentication factors. The authenticator node may compare the double hashed values of the authentication factors with trusted authentication information that is encoded in entity credentials associated with the entity. The authenticator node may determine, based at least in part on comparing the double hashed values of the authentication factors with the trusted authentication information, whether the entity is a trusted entity.

This application claims the benefit of U.S. Provisional Application No. 63/278,866, filed Nov. 12, 2021, the entire content of which is incorporated herein by reference.

### STATEMENT REGARDING FEDERALLY SPONSORED RESEARCH OR DEVELOPMENT

This invention was made with Government support under Contract W56KGU-20-C-0058 and Contract W56KGU-21-C-0060, awarded by the United States Army. The Government may have certain rights in this invention.

### BACKGROUND

Biometric authentication systems may rely on centralized storage of biometric information. If compromised, this biometric data can be exploited for false authentication and authorization.

### SUMMARY

In general, this disclosure describes techniques for secure serverless multi-factor authentication (MFA) that enables entities to securely authenticate their identities at remote facilities without requiring authentication data, such as biometric data, to be stored in a centralized database or a centralized server. An authenticator node that attempts to authenticate an entity (e.g., a user and/or a device) may receive multiple authentication factors, such as passcodes, signatures, biometric information, device metrics, and the like, that is associated with the entity. The authenticator node may also receive trusted and signed authentication information describing a known trusted entity for comparison. This trusted entity information is encoded on entity credentials that may potentially be carried with the entity or may be on a server or another source. The authenticator node device may compare the authentication factors associated with the entity with the trusted authentication information associated with the trusted entity to determine whether the authentication factors associated with the entity match the trusted authentication information, which may indicate whether the entity is the trusted entity.

In some aspects, the techniques described herein relate to a method including: receiving, by one or more processors of a computing device, indications of values of authentication factors associated with an entity; hashing, by the one or more processors, the values of the authentication factors to generate double hashed values of the authentication factors; comparing, by the one or more processors, the double hashed values of the authentication factors with trusted authentication information that is encoded in entity credentials associated with the entity; and determining, based on comparing the double hashed values of the authentication factors with the trusted authentication information, whether the entity is a trusted entity.

In some aspects, the techniques described herein relate to a computing device including: memory; and one or more processors configured to: receive indications of values of authentication factors associated with an entity; hash the values of the authentication factors to generate double hashed values of the authentication factors; compare the double hashed values of the authentication factors with trusted authentication information that is encoded in entity credentials associated with the entity; and determine, based at least in part on comparing the double hashed values of the authentication factors with the trusted authentication information, whether the entity is a trusted entity.

In some aspects, the techniques described herein relate to a non-transitory computer readable storage medium storing instructions that, when executed by one or more processors of a computing device, cause the one or more processors to: receive indications of values of authentication factors associated with an entity; hash the values of the authentication factors to generate double hashed values of the authentication factors; compare the double hashed values of the authentication factors with trusted authentication information that is encoded in entity credentials associated with the entity; and determine, based at least in part on comparing the double hashed values of the authentication factors with the trusted authentication information, whether the entity is a trusted entity.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are block diagrams illustrating an example system for serverless authentication of entities, in accordance with aspects of the present disclosure.

FIGS. 2A-2C illustrate techniques for serverless authentication of both users and devices, in accordance with aspects of the present disclosure.

FIG. 3 illustrates techniques for encoding entity credentials, in accordance with aspects of the present disclosure.

FIGS. 4A and 4B illustrate techniques for encoding biometric data in entity credentials, in accordance with aspects of this disclosure.

FIGS. 5A and 5B illustrates enrollment and authentication of users, in accordance with aspects of the present disclosure.

FIG. 6A-6C illustrates examples of performing scalable and dynamic authentication using many factors, in accordance with aspects of the disclosure.

FIGS. 7A and 7B illustrate a real-time drive-thru passenger identification camera system implemented using the techniques of SSUBIA and MATAS, in accordance with aspects of this disclosure.

FIG. 8 is a block diagram illustrating further details of an example computing device 802, in accordance with one or more aspects of the present disclosure.

FIG. 9 is a flow diagram illustrating example operations in accordance with one or more aspects of this disclosure.

### DETAILED DESCRIPTION

In general, this disclosure describes techniques for secure serverless multi-factor authentication (MFA) that enables entities to securely authenticate the entities' identities at remote facilities without requiring authentication data, such as biometric data, to be stored in a centralized database or a centralized server. The techniques of the disclosure may include the following features:
use of encoding (rounding, combining, then one-way hashing) of analog biometrics to both protect the data, and also allow for comparisons of analog data that has been one-way encoded,
use of two-layers of encoding that enables local and remote serverless and decentralized authentication using certificates and standards (e.g., X.509 certificates and standards),
use of a weighted authentication strength based on several (e.g., “many”, more than 3, more than 10, no maximum value, etc.) authentication factors and techniques, and
works for both people and devices — can use device metrics as “biometrics” (e.g., central processing unit (CPU) clock speeds, etc.).

The techniques of this disclosure may be referred to as Secure Serverless Multi-Factor Biometric Authentication (SSUBIA). SSUBIA enables an entity's authentication data to be stored on encoded secure storage that can be carried by individuals on an ID card or a portable storage device. SSUBIA may improve user authentication, interoperability, and collaboration across the organizations and partners. SSUBIA may reduce the attack surfaces of authentication systems and makes biometric authentication more usable, secure, scalable, and dynamic.

The techniques of this disclosure enable ad hoc credentialling and dynamic authentication in the field with serverless authentication. For example, when two coalition soldiers meet on a battlefield without prior knowledge of each other, either one of the two soldiers could be an unfriendly entity (e.g., an imposter). The solders may authenticate themselves using SSUBIA serverless credentials to prove the soldiers are trusted by a valid trusted root-of-trust, which may not necessarily be the same root-of-trust. In the event that one of the two soldiers is an imposter, SSUBIA also include techniques for embedding distress/duress indicators in the credential, so that if an unfriendly entity attempts to force or trick a soldier into gaining access to a secure system, the solder may use the embedded distress/duress indicators to trigger warnings throughout the system and to prevent the unfriendly entity from gaining access to the secure system.

In some examples, the techniques of this disclosure may encode raw biometric data in SSUBIA credentials using a one-way function that may obviate the need to store raw or encrypted biometric data in centralized storage (e.g., on a remote server). The raw biometric data may be used at the point of enrollment, when sensor readings are taken, to generate SSUBIA credentials and at the point of access where new sensor readings are taken to be compared with the enrollment values encoded in the SSUBIA credentials, thereby allowing personnel or other entities to be authenticated at remote sites/facilities. The biometric data encoding may ensure that the original biometric data cannot be extracted from SSUBIA credentials on which the encoded data has been stored, and individual credentials can also be revoked by the system, thereby increasing the security of the techniques of this disclosure.

The techniques of this disclosure may deliver zero trust and logical/physical access control policies that have been identified by the Department of Defense (DoD) Chief Information Officer (CIO)'s Identity, Credential, and Access Management (ICAM) strategies. The techniques of this disclosure may not only addresses the DoD CIO's near-term goals, but may also incorporates capabilities like automated provisioning, dynamic access, and data tagging. In addition, the techniques of this disclosure may address the needs of organizations such as the U.S. Army and coalition partners.

The techniques of this disclosure may enable enrollment nodes and approved authenticators to authenticate entities anywhere in the world without access to a centralized server. The techniques of this disclosure may potentially protect multiple weak points in existing authentication systems, thereby potentially reducing attack surfaces and improving security. In some examples, the techniques of this disclosure may improve security by:
1. distributing biometric data among the users, eliminating centralized storage;
2. using conventional root trust (e.g., Certificate Authority) to protect the distributed credentials;
3. using one-way biometric data encoding that are used to prevent decrypting, faking, and masquerading; and
4. using access sensors that can be localized and removed from network, to prevent remote control/hacking.

The techniques of this disclosure can be used by large teams with entities in different countries and by groups communicating over radios or internet protocols. The techniques of this disclosure may also be applied to authenticate devices and machines using information and machine data generated by the devices and machines, which can be used to enable advanced ad hoc routing by providing secure and safe authentication of routers and endpoints. The techniques of this disclosure may be applicable to military, government, and broader commercial systems in fleet management, law enforcement, and secure commercial communications needs.

The SSUBIA credential itself may contain multiple biometrics, deactivation date, full name, organization, and any other needed information encoded in the credential as trusted authentication information. There may be no need for servers to authenticate or verify the user. Revocation of SSUBIA credentials may be shared throughout the network using similarly verifiable periodic updates, taking advantage of existing techniques to distribute revocation lists of users (paired with signatures) throughout the system, such as distribution of such revocation lists to certificate authorities around the world.

The techniques of this disclosure may provide the following potential improvements to the authentication ecosystem:
1. enabling the use of one-way hashing and encoding of analog biometrics in a way that both protects the data, but also allows for comparisons of analog data that has been encoded;
2. using two-layers of encoding that enables local and remote serverless authentication using existing X.509 certificates and standards, which provide novel capabilities within a widely accepted and compatible credential that can exist on a Personal Identity Verification (PIV) card, a Common Access Card (CAC), or other device, thereby enabling the techniques of this disclosure to be used in serverless and/or decentralized environments;
3. calculating a weighted authentication strength based on several authentication factors and techniques, which provide secure method for multi-factor authentication cooperatively across many partners, both foreign and domestic; and
4. authenticating both people and devices, or combinations of people and devices, such as via use of device metrics (e.g., CPU clock speeds) as “biometrics” for the device.

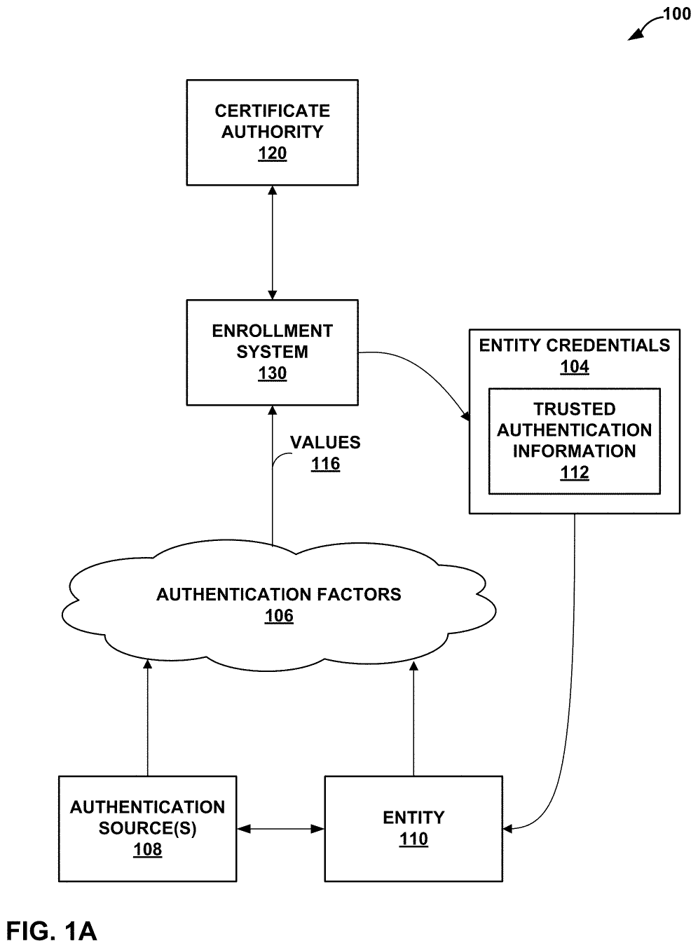

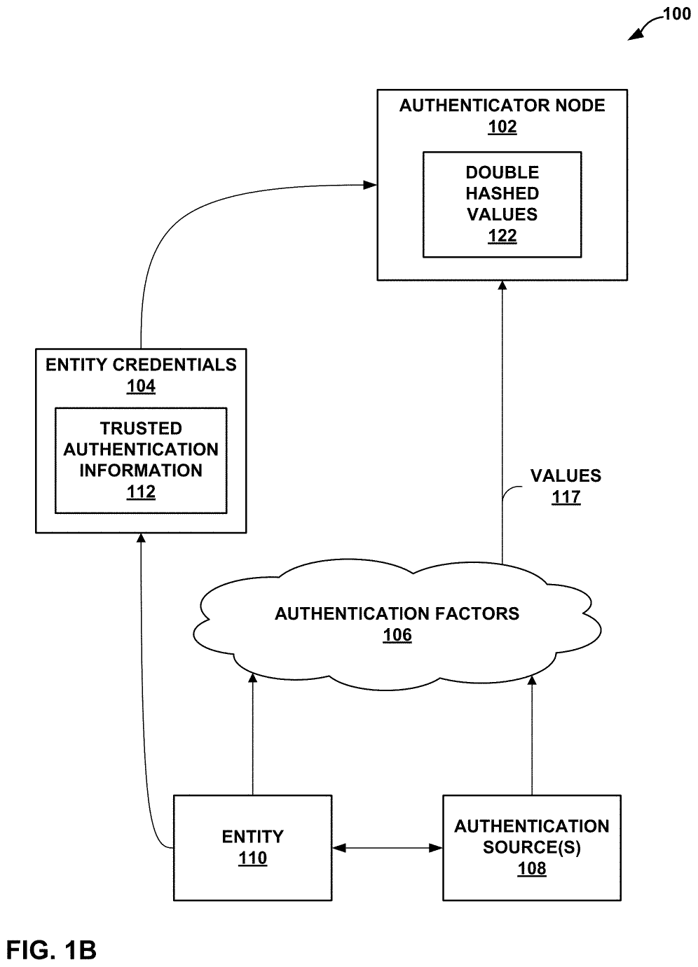

FIGS. 1A and 1B are block diagrams illustrating an example system 100 for enrollment and serverless authentication of entities, in accordance with aspects of the present disclosure. As shown in FIGS. 1A and 1B, system 100 includes enrollment system 130 configure to generate entity credentials 104 for entity 110 that entity 110 may use to authenticate with authenticator node 102.

Enrollment system 130 may include any suitable computing device or computing system configured to generate entity credentials 104 associated with entity 110. Entity credentials 104 associated with entity 110 may store or otherwise specify trusted authentication information 112 associated with entity 110 that can be used by authenticator node 102 to authenticate entity 110. Examples of such trusted authentication information 112 associated with entity 110 stored or specified by entity credentials may include biometric information associated with entity 110, passwords, personal identification numbers (PINs), device characteristics associated with entity 110, or any other information that can be used by authenticator node 102 to authenticate entity 110. Trusted authentication information 112 may also include a deactivation date, which may be a date after which the trusted authentication information 112 is no longer valid, full name, organization, and any other information that can be used to authenticate entity 110 associated with entity credentials 104.

In some examples, enrollment system 130 may communicate with or may perform the actions of certificate authority 120 to digitally sign trusted authentication information 112 stored in or specified by entity credentials 104 or to generate entity credentials 104 in the form of a digital certificate, such as a public key certificate so that authenticator node 102 can verify whether trusted authentication information 112 stored or specified by entity credentials 104 is trusted. For example, trusted authentication information 112 may be digitally signed in the form of a public key certificate, such as a public key certificate that conforms to the X.509 standard (also referred to as an X.509 certificate), a digital certificate that follows and/or extends the format of an X.509 certificate, or via any other suitable certificate signing techniques or formats. Examples of entity credentials 104 include a portable storage device such as flash drives and/or Universal Serial Bus (USB) data drives (or key), an access card (e.g., a Common Access Card (CAC), Personal Identity Verification (PIV) card, etc.), a mobile computing device (e.g., a smart phone), an identification card, a token, or any other device or object that stores or otherwise specifies trusted authentication information 112 that can be used by authenticator node 102 to authenticate entity 110.

Entity 110 may enroll at enrollment system 130 in order to generate trusted authentication information 112 to be stored in an associated entity's entity credentials 104, and entity 110 may use trusted authentication information 112 stored in entity credentials 104 to authenticate entity 110 with authenticator node 102. During enrollment, entity 110 and/or one or more authentication sources 108 may transmit, to enrollment system 130, values 116 of multiple authentication factors 106 of the entity 110.

Authentication factors 106 may include any information associated with entity 110 that can be used for authenticating entity 110. For example, if entity 110 is a person, each authentication factor may be a passcode, signature, profile data, biometric information, or other authentication data. Examples of authentication factors 106 may include any combination of: a password, a PIN, electrocardiogram (ECG) data, heart rate data, a voice print, a location, a handprint, a fingerprint, a retina scan, an ear print, a radio frequency identification, a gait, keystrokes, a pattern of keystrokes, and the like.

In some examples, if entity 110 includes or is a device, such as a computing device being used by a user, authentication factors 106 may include authentication factors of the user, such as biometric information and other factors as described above, and/or may also include authentication factors associated with the device. For example, the authentication factors associated with the device may include data regarding the processor(s) of the device such as the clock speed(s) of the processor(s) and the pattern of usage of the processor(s), application profiles of applications executing at the device, a media access control (MAC) address of the network card, universally unique identifier (UUID) codes for hardware components of the device, certificates associated with the device, location data, a radio frequency identification, and the like.

In some examples, if entity 110 includes or is a vehicle (e.g., a motor vehicle, or UAS) driven by a user, authentication factors 106 may include authentication factors of the user, such as biometric information and other factors as described above, and may also include authentication factors associated with the vehicle. For example, the authentication factors associated with the vehicle may include an engine print (e.g., a print of the sound of the vehicle's engine), a vibration or sound print, a pattern of keystrokes entered by the user at the vehicle, a password entered by the user at the vehicle, the proximity information associated with the vehicle, location information associated with the vehicle, voice prints of the user of the vehicle, and the like.

One or more authentication sources 108 may generate authentication factors 106 associated with entity 110. One or more authentication sources 108 may include any combination of local authentication sources and/or remote authentication sources. In some examples, a local authentication source may be an authentication source that is a part of authenticator node 102 or is directly connected to authenticator node 102, while a remote authentication source may be an authentication source remote from authenticator node 102, such as an authentication source connected to authenticator node 102 via a network.

Examples of one or more authentication sources 108 may include any combination of a voice recognition sensor, a global positioning system, a shoe tap input sensor, a finger tap input sensor, a hand geometry sensor, a hand grip sensor, a fingerprint sensor, an electrocardiogram (ECG) sensor, an ear print sensor, a radio frequency identification tag, a proximity sensor, a password entry device, a radio device, a gait sensor, a keystroke analyzer device, and the like. In some examples, one or more authentication sources 108 may include authentication sources within entity 110. For example, if entity 110 is a computing device, authentication sources 108 may include system logs generated by entity 110, profiling data generated by entity 110, and the like.

One or more authentication sources 108 may determine values 116 of authentication factors 106, and entity 110 and/or one or more authentication sources 108 may send indications of the values 116 of authentication factors 106 to enrollment system 130 to generated trusted authentication information 112 to be stored in entity credentials 104 associated with entity 110. For example, one or more authentication sources 108 may take biometric measurements of entity 110, and may send indications of such biometric measurements of entity 110 as values 116 of authentication factors 106 to enrollment system 130.

Enrollment system 130 may receive indications of values 116 of authentication factors 106 from entity 110 and/or one or more authentication sources 108 and may calculate secret values from values 116 of authentication factors 106 to create trusted authentication information 112 for the entity 110 as a unique template or credential, such as entity credentials 104. In some examples, enrollment system 130 encodes the value of each authentication factor in the trusted authentication information 112 using one-way hashing to generate an authentication factor value. By encoding an authentication factor using one-way hashing, the original value(s) of the authentication factor cannot be exfiltrated or in any way determined from the authentication factor value encoded in the entity credentials.

Specifically, because the value of an authentication factor may include or may be analog data, such as analog biometric readings, the value of each authentication factor may be rounded and hashed to both mask the original value of the authentication factor and to enable such analog data to be compared, for the purposes of authenticating an entity 110. In some examples, enrollment system 130 may perform multiple layers (e.g., two layers) of hashing on each of the authentication factor to generate a hash value for each of the authentication factors 106 that is encoded in the trusted authentication information 112. That is, enrollment system 130 may hash each value of the authentication factors 106 to generate a first set of hashed authentication factor values, and may hash each of the first set of hashed authentication factor values of the authentication factors to generate a second set of hashed authentication factor values. In some examples, in addition to hashing values 116 of authentication factors 106, enrollment system 130 may hash and/or encrypt each value of the authentication factors, such as each authentication factor value of the second set of hashed authentication factor values, and then enrollment system 130 may encode the resulting hashed value of each of the authentication factors in the trusted authentication information 112.

The trusted authentication information 112 for the entity is securely encoded in entity credential 104 that can be shared between backend servers, and/or carried with the entity 110 on a data storage device, such as on a USB drive or encoded within a Common Access Card. This trusted authentication information 112 is signed by the certificate authority 120 and by the entity 110 and can be used at any authenticator node, such as authenticator node 102, having the same root of trust as entity credentials 104, or another trusted root certificate authority.

The trusted authentication information 112 can be validated and verified by an authenticator node 102 by checking the certificate authority signature of the trusted authentication information 112. That is, authenticator node 102 may verify the certificate authority signature in entity credentials 104 to determine whether the certificate authority signature is valid. Authenticator node 102 may also communicate with a certificate authority, such as certificate authority 120, to determine whether the certificate authority signature has been revoked.

As shown in FIG. 1B, system 100 includes authenticator node 102. Authenticator node 102 may include any suitable computer, computing device, or computing system configured to authenticate entities based on authentication factors to determine whether an entity is a trusted entity. The authenticator node 102 can verify (e.g., authenticate) an entity 110 by receiving indications of values 117 of authentication factors 106 associated with entity 110, such as local biometric measurements and readings by one or more authentication sources 108, and comparing values 117 of authentication factors 106 associated with the entity 110 with the trusted authentication information 112 encoded in the entity credentials 104 to authenticate the entity 110. Such authentication of the entity 110 without requiring raw data, original data decoding, a back-end server connection, or any other server. Once created, the trusted authentication information 112 for an entity 110 may remain valid until the information is revoked, modified, or corrupted. The trusted authentication information 112, such as biometric data, may be safe and non-recoverable regardless of whether the trusted authentication information 112 is modified. Certificate authority 120 may share revocations of authorized entities may be shared throughout a network and/or system of authenticator nodes using similarly verifiable periodic updates, taking advantage of existing techniques to distribute revocation lists of entities paired with signatures throughout the network and/or system of certificate authorities and authenticator nodes.

In some examples, if authenticator node 102 authenticates an entity as a trusted entity, authenticator node 102 may grant the entity access to secure resources. Entity 110 may include a living being (e.g., a person), a computing device, a vehicle (e.g., a car, an unmanned aircraft system, etc.), or any other entity and/or combinations thereof that may be authenticated by authenticator node 102 to determine whether entity 110 is a trusted entity.

Entity 110 may attempt to authenticate itself with authenticator node 102 by providing entity credentials 104 associated with entity to authenticator node 102. That is, entity 110 may situate entity credentials 104 such that authenticator node 102 may be able to read, scan, or otherwise receive indications of trusted authentication information 112 encoded in entity credentials. For example, if entity credentials 104 is an identification card that encodes trusted authentication information 112 in the form of a bar code, entity 110 may position entity credentials 104 in front of a bar code scanner of authenticator node 102 so that entity 110 may scan the bar code of entity credentials 104 to read trusted authentication information 112. In another example, if entity credentials 104 is a flash drive, entity 110 may plug entity credentials 104 into a port of authenticator node 102 so that entity 110 is able to access trusted authentication information 112 stored in entity credentials 104.

Entity 110 may, in addition to providing entity credentials 104, also provide indications of values 117 of authenticator factors 106 to authenticator node 102. That is, one or more authentication sources 108 may determine current values 117 of authenticator factors 106, such as current biometric readings of entity 110. In some examples, one or more authentication sources 108 may determine values 117 of three or more authentication factors 106 as well as one or more techniques from each of authentication factors 106. For example, one or more authentication sources 108 may determine values 117 of the same set of authentication factors 106 as the set of authentication factors 106 used to generate trusted authentication information 112.

One or more authentication sources 108 and/or entity 110 may send indications of the values 117 of authenticator factors 106 to authenticator node 102 to authenticate entity 110 as a trusted entity. That is, entity 110 may send indications of the values 117 of authenticator factors 106 to authenticator node 102 so that authenticator node 102 may compare the values of authenticator factors 106 with trusted authentication information 112 to determine whether entity 110 is a trusted entity.

In some examples, because trusted authentication information 112 is encoded in entity credentials 104 via two layers of one-way hashing, authenticator node 102, authenticator node 102 may not be able to directly compare values of authentication factors 106 with trusted authentication information 112. Instead, values of authentication factors 106 may similarly have to be hashed via two layers of one-way hashing in order for authenticator node 102 to compare values 117 of authentication factors 106 with trusted authentication information 112.

In accordance with aspects of this disclosure, entity 110 and/or one or more authentication sources 108 may, in response to determining values 117 of authentication factors 106, send an indication of values 117 of authentication factors 106 to authenticator node 102. Authenticator node 102 may receive an indication of values 117 of authentication factors 106 from entity 110 and/or one or more authentication sources 108 and may perform a one-way hashing of values 117 of authentication factors 106 to generate, based at least in part on hashing values 117, double hashed values 122 of authentication factors 106 that have been hashed via two layers of one-way hashing. That is, authenticator node 102 may perform two layers of hashing of each value of values 117 to generate a double hashed value for each of authentication factors 106.

Authenticator node 102 may therefore attempt to authenticate entity 110 by comparing the double hashed values 122 of authentication factors 106 with trusted authentication information 112 stored and/or encoded on entity credentials 104 associated with entity 110. Because the values in trusted authentication information are ended using two layers of hashing, authenticator node 102 may, for each authentication factor of authentication factors 106, compare the double hashed value of the authentication factor with a corresponding double hashed value of the authentication factor in trusted authentication information 112. That is, for example, if authentication factors 106 includes a fingerprint, authenticator node 102 may compare the double hashed values of fingerprint data of authentication factors 106 with the double hashed values of fingerprint data encoded in trusted authentication information 112. Authenticator node 102 may, based on comparing the double hashed value of each authentication factor of authentication factors 106 with a double hashed trusted value of the corresponding authentication factor in in trusted authentication information 112, determine whether entity 110 is a trusted entity. Authenticator node 102 may, in response to determining that entity 110 is a trusted entity, grant entity 110 access to one or more secured services, devices, systems, locations, and the like.

In some examples, authenticator node 102 may assign a weight to each authentication factor of authentication factors 106. Such a weight for an authentication factor may be based on, for example, the sensor reading quality of the authentication factor or any other suitable factor. Authenticator node 102 may generate a single authentication value based on the weights and based on comparing the double hashed value of each authentication factor of authentication factors 106 with a double hashed trusted value of a corresponding authentication factor in trusted authentication information 112. In other words, authenticator node 102 performs a composite weighting of each available authentication input to generate the single authentication value, which authenticator node 102 uses to determine whether entity 110 is a trusted entity.

Authenticator node 102 may determine whether entity 110 is a trusted entity based on the generated authentication value, such as by determining whether the authentication value exceeds a pass/fail threshold. If authenticator node 102 determines that the generated authentication value exceeds the pass/fail threshold, authenticator node 102 may determine that entity 110 is a trusted entity.

In some examples, authenticator node 102 may adjust the pass/fail threshold for different situations, such as for different levels of assuredness that an entity is a trusted entity. For example, authenticator node 102 may increase the pass/fail threshold to increase the level of assuredness that an entity is a trusted entity, such as when authenticator node 102 is attempting to protect access to highly secure locations, materials, etc., while authenticator node 102 may decrease the pass/fail threshold to decrease the level of assuredness that an entity is a trusted entity, such as when authenticator node 102 is attempting to protect access to less secure locations, materials, etc.

In one example, authenticator node 102 may compare and weigh the values of five authentication factors 106 to determine whether an entity is allowed to enter a secure facility as follows:

| | | | | |
|---|---|---|---|---|
| a) | PIN (voice) | max: 100 | 100% match to trusted entity | 100 |
| b) | Body match | max: 70 | 95% match to trusted entity | 66 |
| | (to CAC) | | | |
| c) | Facial (visual) | max: 120 | 90% match to trusted entity | 108 |
| d) | Facial (IR) | max: 70 | 95% match to trusted entity | 66 |
| e) | Ear match | max: 70 | 80% match to trusted entity | 56 |
| f) | Total | 430 | 92% | 396 |

The result is an authentication value of 396, which is 92% of the maximum authentication value 430 of the five authentication factors 106. If the authentication threshold is 400, which may be an example threshold for a classified facility having a relatively high threshold, then authenticator node 102 may determine that entity 110 is not a trusted entity and therefore is not allowed to access the secure facility. However, if the pass/fail threshold is 250, which may be an example threshold for a general military facility having a relatively lower threshold, then authenticator node 102 may determine that entity 110 is a trusted entity and therefore is allowed to access the secure facility.

In another example, authenticator node 102 may determine the average authentication quality of the authentication value, and determine whether an entity is a trusted entity based on the average authentication quality of the authentication value. In the example above where the authentication value of 396 has an average authentication quality of 92%, authenticator node 102 may determine whether the average authentication quality of the authentication value is higher than a required minimum quality, such as 75% or 85%, to determine whether the entity is a trusted entity. The thresholds can be adjusted for each access-controlled door or computer system.

In some examples, an entity 110 may signal duress and/or distress by causing authentication factors 106 to include an authentication factor indicative of entity 110 being under duress and/or distress. In some examples, entity 110 may be under duress and/or distress may occur when entity 110 is forced or tricked into authenticating entity 110 with authenticator node 102. For example, entity 110 may input a specific password, make a specific facial expression (e.g., wink with their left eye), etc. as an authentication factor to indicate that entity 110 is under duress. Authenticator node 102 may, in response to determining that authentication factors 106 include an authentication factor indicative of entity 110 being under duress and/or distress, take one or more actions, such as refraining from authenticating entity 110 as a trusted entity, contacting (e.g., alerting) one or more people or other entities, and/or redirecting access to another entity acting as a honeypot or trap, etc.

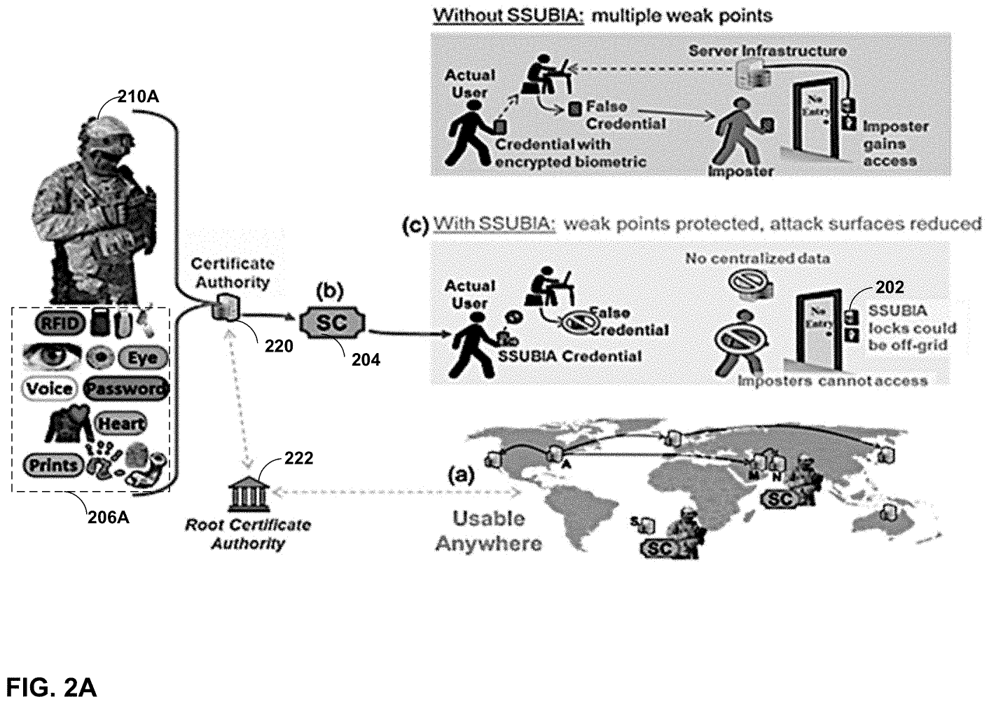

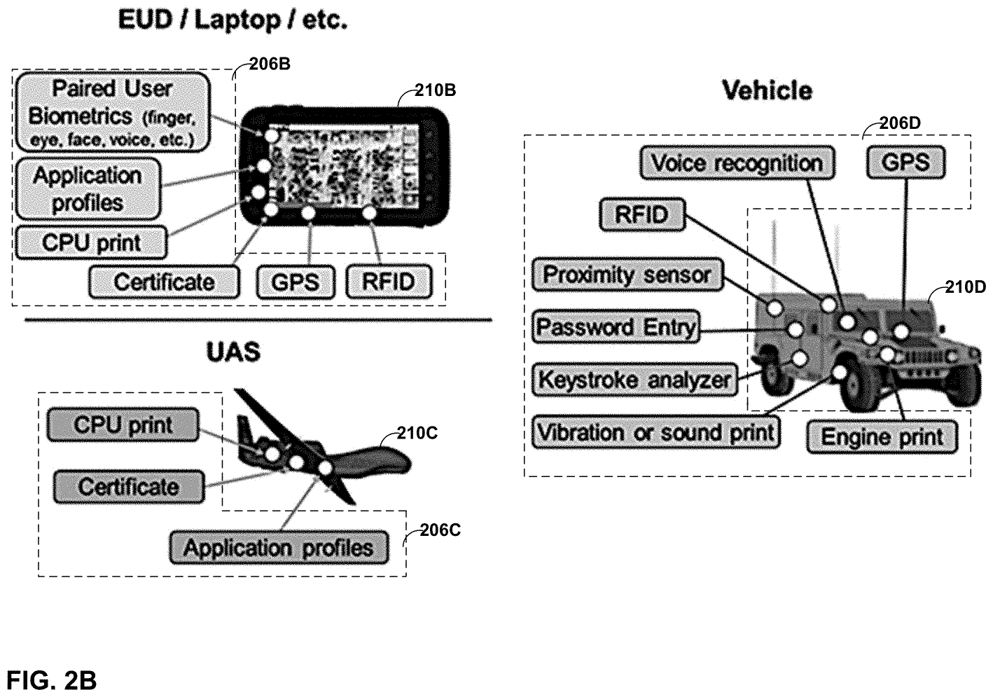

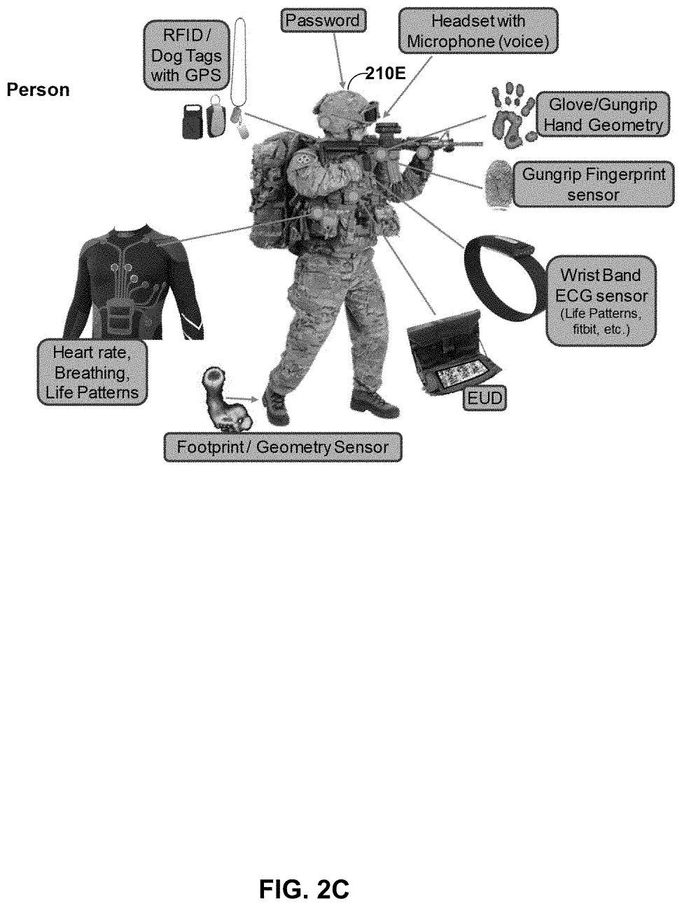

FIGS. 2A-2C illustrate techniques for serverless authentication of both users and devices, in accordance with aspects of the present disclosure. As shown in FIG. 2A, SSUBIA may enable users, such as entity 210A, which is an example of entity 110 shown in FIG. 1, to enroll at different Certificate Authorities, such as Certificate Authority 220 throughout trusted coalition partner countries and then authenticate anywhere in the SSUBIA-enabled network.

During enrollment, an enrollment system reads and/or measures multiple biometric values of authentication factors 206A of a user, such as entity 210A, and calculates secret values from these measurements, creating a unique template or credential, such as entity credentials 204, which is an example of entity credentials 104 shown in FIG. 1, that is associated with entity 210A. In some examples, certificate authority (CA) 220, which is an example of certificate authority 120, may be a root certificate authority, such as root certificate authority 222, may digitally sign entity credentials 204, and entity credentials 204 may be a root certificate that identifies root certificate authority 222, which may enable entity 210A to be authenticated using credentials 204 at authentication nodes across the world.

Entity credentials 204 are secure and can be shared between backend servers, carried with entity 210A on a USB drive, or encoded within a Common Access Card (CAC). Credentials 204 are signed by CA 220 and by the user (i.e., entity 210A) and can be used at any SSUBIA-enabled authenticator node. For example, authenticator node 202, which is an example of authenticator node 102 shown in FIG. 1, may be a keyless entry device for a door that governs access to the door. Entity 210A may provide entity credentials 204 to authenticator node 202, such as by swiping entity credentials 204, holding entity credentials 204 within a close range (e.g., a few inches) of authenticator node 202, and the like, so authenticator node 202 may read the trusted information encoded in entity credentials 204.

Authenticator node 202 may validate and verify entity credentials 204 by checking the CA signature in credentials 204. Authenticator node 202 may, upon validation of entity credentials 204, attempt to verify entity 210A as a trusted entity by comparing local biometric measurements and readings, such as the values of authentication factors 206A, which are examples of authentication factors 106 shown in FIG. 1, with the encoded data in credentials 204 to authenticate entity 210A. This may be done without requiring original data decoding or a back-end server connection or any other server. Once created, credentials 204 remain valid until they are modified, revoked, or corrupted.

In some examples, authenticator node 202 may, upon successfully verifying entity 210A as a trusted entity, grant entity 110 access to a secured resource. In the example where authenticator node 202 is a keyless entry device for a door, authenticator node 202 may, upon successfully verifying entity 210A as a trusted entity, unlock the door.

As shown in FIG. 2B, when an entity is a device or a person that uses the device, the device may also produce values of authentication factors that can be used to verify the entity as a trusted entity. Such authentication factors may include machine data, which may be data produced by a device in operation. In the example where entity 210B is an end user device such as a laptop, tablet computer, or any other computing device, authentication factors 206B associated with entity 210B may include RFID information, Global Positioning system (GPS) information, a digital certificate, a Central Processing Unit (CPU) print of the device, application profiles of applications executing at entity 210B, as well as biometric information of the user of the device captured by in biometric sensors of the device. The CPU print and the application profiles may be examples of machine data that can be used as authentication factors.

In the example where entity 210C is an unmanned aerial system, such as an unmanned aerial vehicle, authentication factors 206C associated with entity 210C may include application profiles of applications executing at entity 210C, a CPU print of entity 210C, a digital certificate, and the like. In the example where entity 210D is a vehicle, such as a motor vehicle, authentication factors 206D associated with entity 210D may include a GPS information, a voice recognition, RFID information, proximity sensor information, a password, keystroke analysis information, vibration or sound print, and/or an engine print.

As shown in FIG. 2C, when entity 210E is a person, a variety of authentication sources may be used to capture a variety of information that may be used to authenticate entity 210E. Examples of authentication sources and authentication factors for entity 210E may include a password entered by the user, dog tags that include an RFID chip and/or a GPS sensor for capturing information about entity 210E such as location information, a specialized suit worn by entity 210E to capture biometric information regarding entity 210E such as heart rate, breathing patterns, and/or life patterns, a foot print sensor to capture the foot print and/or foot geometry of entity 210E, an end user device used by entity 210E, a wrist band worn by the sensor to capture heart rate information and/or electrocardiogram (DCG) information, a gun grip fingerprint sensor to capture the finger print of entity 210E, a glove that captures the finger print and/or the hand geometry of entity 210E, a headset with a microphone that captures entity 210E's voice, and the like.

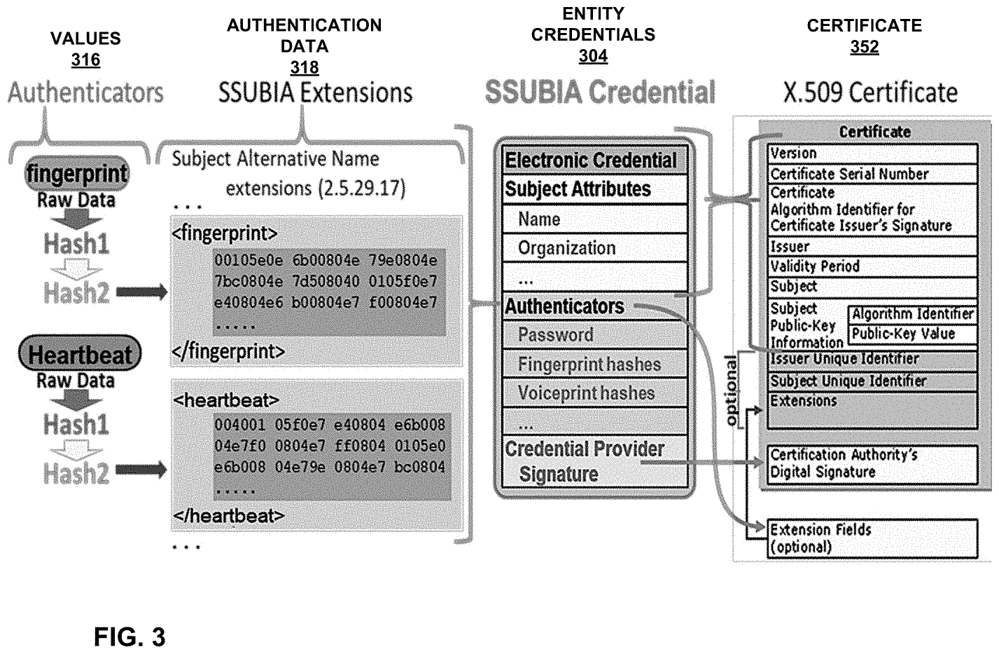

FIG. 3 illustrates techniques for encoding entity credentials, in accordance with aspects of the present disclosure. Entity credentials, such as SSUBIA encoded credentials may utilize existing key and root of trust methods (keys, signatures, certificates, etc.). In some examples, entity credentials, also referred to as SSUBIA certificates, may follow the structure of X.509 certificates, and/or may use a modified or extended structure of X.509 or other certificates. Encoding an entity credential may include rounding, combining, and hashing of data to make analog data both masked (e.g., un-hashable back to an un-hashed state) and comparable, for the purposes of authentication. An entity credential may also be encoded using two layers of hashing to enable both local (one layer) and remote (two-layer) authentication.

As shown in FIG. 3, an enrollment system, such as enrollment system 130 shown in FIG. 1A, may generate entity credentials 304, which are an example of entity credentials 104 shown in FIG. 1A, based on values 316 of authentication factors, which are an example of values 116 of authentication factors 106 of FIG. 1A, of an entity. Such entity credentials 304 may be signed by a certificate authority, such as root certificate authority or a certificate authority that is associated with and/or communicates with the root certificate authority. In the example of FIG. 3, values 316 of the authentication factors may include fingerprint data associated with the entity and heartbeat data associated with the entity. That is, in the example of FIG. 3, the Enrollment system may encode the values of two authentication factors: values of the authentication factor of fingerprints and may also include values of the authentication factor of heartbeats.

The enrollment system may perform rounding, combining, and two layers of hashing of each value of the authentication factors to enable both local (one layer) and remote (two-layer) authentication and to generate authentication data 318 that includes the hashed fingerprint data and the hashed heartbeat data. In the example of FIG. 3, the enrollment system may perform two layers of hashing on the rounded and combined fingerprint data to generate hashed fingerprint data in authentication data 318. Similarly, the enrollment system may perform two layers of hashing on the rounded and combined heartbeat data to generate hashed fingerprint data in authentication data 318.

The enrollment system may use the generated authentication data 318 to generate entity credentials 304. Entity credentials 304 may identify the entity for which entity credentials 304 are created and may also include trusted authentication information, which is an example of trusted authentication information 112 shown in FIG. 1 that includes authentication data 318. The certificate authority may, in some examples, digitally sign entity credentials 304. The certificate authority may sign entity credentials 304 to generate certificate 352 in the form of an X.509 certificate

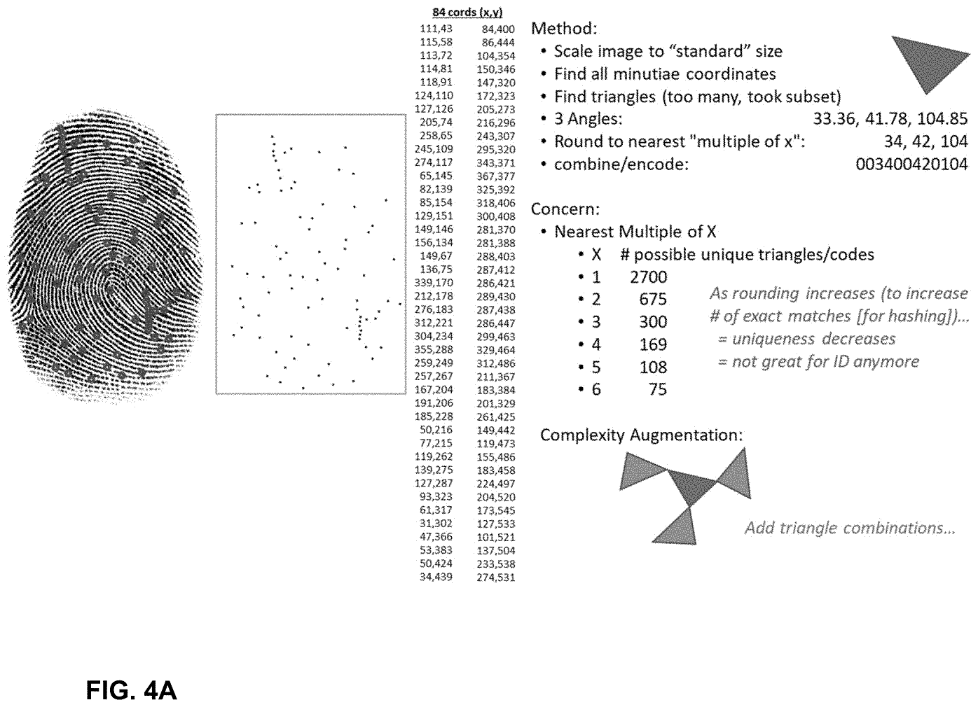

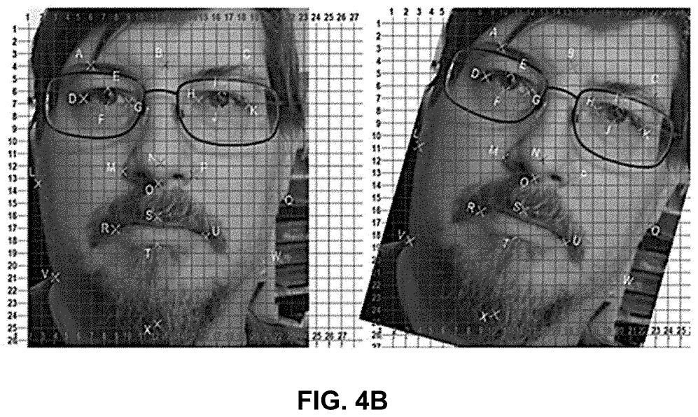

FIGS. 4A and 4B illustrate techniques for encoding biometric data in entity credentials, in accordance with aspects of this disclosure. As described in this disclosure, authentication factors, such as authentication factors 106 shown in FIG. 1, may include biometric data such as fingerprint data, and an enrollment system may round, combine, and hash such biometric data to encode the biometric data in entity credentials. Similarly, biometric data such as fingerprint data may be rounded, combined, and hashed so that an authenticator node may compare such biometric data with the biometric data encoded in entity credentials.

As shown in FIG. 4A, when encoding fingerprint data in entity credentials and/or when such fingerprint data are used to performing fingerprint matching for the purposes of authenticating an entity, an apparatus such as an enrollment system (e.g., enrollment system 130 shown in FIG. 1) and/or a computing device associated with an entity (e.g., entity 110 shown in FIG. 1) may use fingerprint minutiae organized into triplets and then calculating angles to match fingerprints for the purposes of encoding and/or fingerprint data.

A computing device, such as a fingerprint reader (e.g., as part of one or more authentication sources 108 shown in FIG. 1), may read the fingerprint of a person, such as an entity, to capture a fingerprint image. In some examples, the computing device may encode fingerprint data based on the fingerprint image. In other examples, the computing device may send the fingerprint image to an enrollment system for encoding into fingerprint data.

When encoding fingerprints, a computing device may use a combination of triplets and/or triangles to create more complex structures to be hashed and stored in SSUBIA credentials for later comparison. Specifically, the computing device may scale the received image to a specified size and may find all or at least a portion of the fingerprint minutiae in the fingerprint image.

The computing device may determine all or a subset of the triangles of the minutiae in the fingerprint image, and may, for each triangle found by the Enrollment system, determine the three angles of the triangle. In the example of FIG. 4A, for an example triangle, the angles may be 33.36 degrees, 41.78 degrees, and 104.85 degrees. The computing device may round each of the angles of each of the triangles to a nearest multiple of “X”. As such, for the example triangle having angles of 33.36 degrees, 41.78 degrees, and 104.85 degrees, the computing device may round the angles to 34 degrees, 42 degrees, and 104 degrees, respectively. The computing device may combine the rounded angles of 34, 42, and 104 as 0034004200104.

The enrollment system may encode the rounded and combined values of the angles of the triangles in the entity credentials associated with the entity by performing two layers of hashing of the rounded and combined values of the angles of the triangles. In this way, the computing device may combine and round fingerprint data. In this way, an authenticator node, when performing fingerprint matching, may use the angles between three points or minutiae of a fingerprint to be able to create a rotation and/or size independent way of matching fingerprints by allowing for rotational comparison of hashed values.

As shown in FIG. 4B, other types of biometric data besides fingerprint data can also be used as authentication data for authenticating entities. For example, facial points for the purposes for performing facial recognition can be processed and encoded in entity credentials using techniques similar to that described in FIG. 4A for encoding fingerprint minutiae. In particular, the techniques described with respect to FIG. 4A for performing fingerprint encoding and matching can also address rotational differences in fingerprint images and other biometrics such as faces, irises, and/or devices. Specifically, the enrollment system may determine minutiae in those biometrics, determine triangles of the determined minutiae, determine angles in the determined triangles, round the determined angles, and encode the rounded angles to encode biometric data in the entity credentials. Similarly, an entity may use techniques similar to that described in FIG. 4A to encode other biometric data that is to be used to authenticate the entity as a trusted entity.

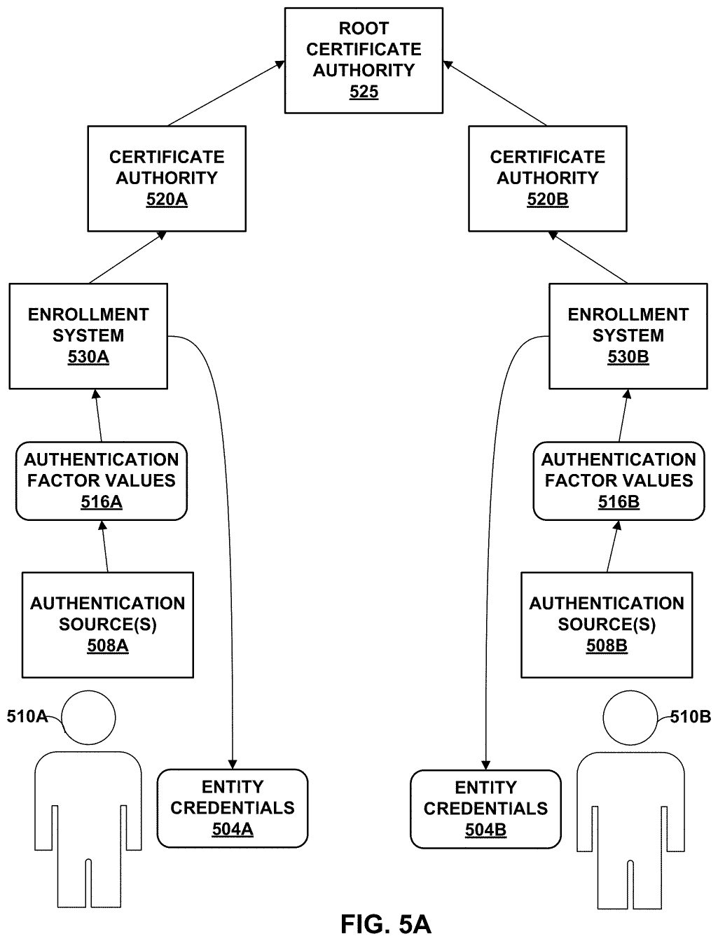

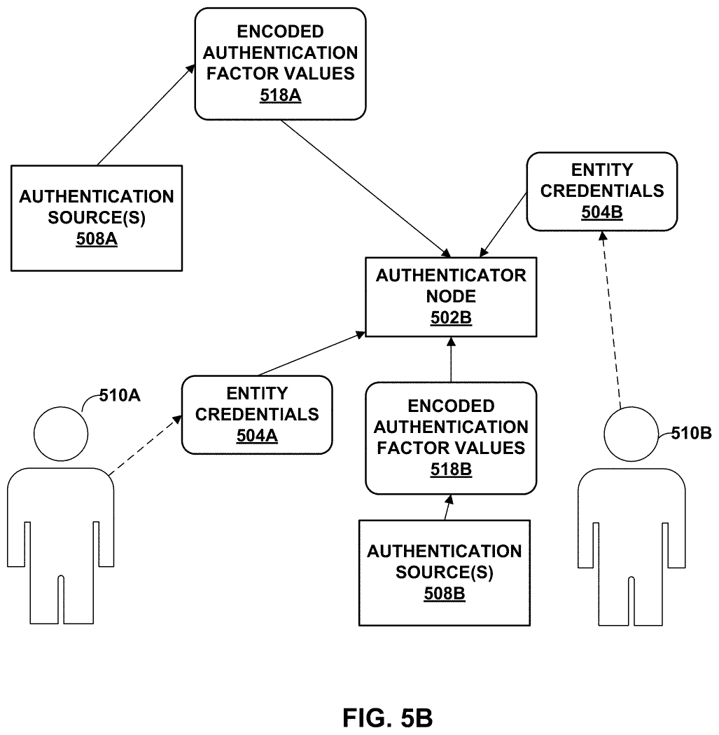

FIGS. 5A and 5B illustrates enrollment and authentication of users, in accordance with aspects of the present disclosure. Such enrollment and authentication of users may be examples of the SSUBIA protocol. When a user enrolls into the SSUBIA system, the system creates SSUBIA Credentials with multiple forms of authentication, such as three forms of authentication, ten forms of authentication, and the like, such that the authentication factors may include multiple factors and multiple techniques. The forms of authentication are all encoded in the SSUBIA Credentials, which are signed by a common root of trust and stored with the user (e.g., in a Common Access Card carried by the user) and optionally on a remote computing system (e.g., in a central database). The SSUBIA protocol enables local authentication as follows, in any suitable order:
have SSUBIA Credential,
read local available authentication sensors,
encode output of the auth sensors,
compare the encoded outputs with the SSUBIA credential data.

The SSUBIA protocol enables remote authentication as follows, in any suitable order:
exchange SSUBIA Credential,
remotely validate credential (e.g., root signatures),
read local authentication sensors,
perform first step of encoding the output of the authentication sensors
send first layer encoded output to remote system, (e.g., using Secure Socket Layer or other communication encryption techniques),
remote system performs second step of encoding the output of the authentication sensors, and
compare the encoded output with the SSUBIA credential.

As shown in FIG. 5A, entity 510A, which is an example of entity 110 shown in FIGS. 1A and 1B, may enroll at enrollment system 530A, which an example of enrollment system 130 shown in FIG. 1A, and certificate authority 520A, which is an example of certificate authority 120 shown in FIG. 1A, to generate entity credentials 504A, which is an example of entity credentials 104 shown in FIGS. 1A and 1B, that contains SSUBIA credentials associated with entity 510A to authenticate entity 510A at authenticator nodes. Similarly, entity 510B, which is an example of entity 110 shown in FIGS. 1A and 1B, may enroll at enrollment system 530B, which is an example of enrollment system 130 shown in FIG. 1A, and certificate authority 520B, which is an example of certificate authority 120 shown in FIG. 1B, to generate entity credentials 504B, which is an example of entity credentials 104 shown in FIG. 1, that contains SSUBIA credentials associated with entity 510B to authenticate entity 510B at authenticator nodes.

Entity 510A may enroll at enrollment system 530A and certificate authority 520A by providing authentication factor values 516A associated with entity 510A to enrollment system 530A, such as via a computing device (not shown) that collects or generates authentication factor values 516A and transmits indications of authentication factor values 516A to enrollment system 530A (e.g., via a network). Authentication factor values 516A may be an example of values 116 of authentication factors 106 shown in FIG. 1. Enrollment system 530A may encode authentication factor values 516A in entity credentials 504A, such as by using the techniques described above with respect to FIGS. 4A and 4B, and certificate authority 520A may digitally sign the encoded authentication factor values 516A in entity credentials 504A.

Similarly, entity 510B may enroll at enrollment system 530B and certificate authority 520B by providing authentication factor values 516B associated with entity 510B to enrollment system 530B, such as via a computing device (not shown) that collects authentication factor values 516B and transmits indications of authentication factor values 516B to enrollment system 530B (e.g., via a network). Authentication factor values 516B may be an example of values 116 of authentication factors 106 shown in FIG. 1. Enrollment system 530B may encode authentication factor values 516B in entity credentials 504B, such as by using the techniques described above with respect to FIGS. 4A and 4B, and certificate authority 520B may digitally sign the encoded authentication factor values 516B in entity credentials 504B.

Certificate authority 520A and certificate authority 520B have the same root certificate authority 525. Authenticator nodes, such as authenticator node 102 shown in FIG. 1B, may be able to authenticate entity credentials having the same root of trust as the authenticator nodes, or another valid root certificate authority. As such, because both entity 510A and entity 510B are associated with entity credentials 504A and 504B signed by certificate authorities 520A and 520B having the same root certificate authority 525, entity 510A and 510B may have the same root of trust and therefore the public key of certificate authority 525, which enables entity 510A and entity 510B to attempt to authenticate each other as friendly entities using the public key of certificate authority 525.

When entity 510A and entity 510B meet, such as on the battlefield, a command post, and the like, entity 510A and entity 510B may exchange entity credentials 504A and 504B, so that entity 510A and entity 510B may each verify whether the other entity is a friendly entity. As shown in FIG. 5B, entity 510B may verify whether entity 510A is a friendly entity by receiving, from entity 510A, entity credentials 504A associated with entity 510A. For example, entity 510A may hand a Common Access Card containing entity credentials 504A to entity 510B.

Entity 510B may use authenticator node 502B, which may be a computing device (e.g., a smart phone or other suitable mobile computing device) and which is an example of authenticator node 102 shown in FIG. 1, to verify whether entity 510A is a friendly entity. Authenticator node 502B may read entity credentials 504A and may verify the signature of certificate authority 520A using a shared root certificate public key, which authenticator node 502B has from a list of trusted root certificate authorities (including root certificate authority 525). Authenticator node 502B may therefore verify whether entity 510A associated with entity credentials 504A has an acceptable root of trust and/or verify whether the digital signature in entity credentials 504A is still valid (e.g., has not been revoked) to verify entity credentials 504A as valid entity credentials.

Authenticator node 502B, may determine entity credentials 504A have been successfully verified as valid entity credentials that indicates entity 510A associated with entity credentials 504A has a valid root of trust as entity 510B. In response to authenticator node 502B successfully verifying entity credentials 504A, authenticator node 502B may perform authentication of entity 510A. That is, authenticator node 502B may determine whether entity 510A is actually associated with entity credentials 504A, in order to prevent possibly malicious entities or other unauthorized entities from attempting to authenticate themselves using entity credentials 504A.

To authenticate entity 510A, authenticator node 502B may read encoded authentication factor values 518A and 518B generated from authentication factors associated with entity 510A. Encoded authentication factor values 518A may be authentication factor values provided by one or more authentication sources 508A associated with entity 510A, and encoded authentication factor values 518B may be authentication factor values provided by one or more authentication sources 508B associated with entity 510B. That is, entity 510A may be, wear, carry, or otherwise use authentication sources 508A, examples of which are described above with respect to FIG. 2C, to collect authentication factor values from entity 510A to generate encoded authentication factor values 518A, and may send encoded authentication factor values 518A to authenticator node 502B, such as via communication channels (e.g., wireless communication channels such as Bluetooth, radio communications, radio-frequency identification (RFID), etc.) between one or more authentication sources 508A and authenticator node 502B. Similarly, entity 510B may wear, carry, or otherwise use authentication sources 508B to collect authentication factor values from entity 510A to generate encoded authentication factor values 518B associated with entity 510A, and may similarly send encoded authentication factor values 518B to authenticator node 502B, such as via communication channels (e.g., wireless communication channels such as Bluetooth, radio communications, radio-frequency identification (RFID), etc.) between one or more authentication sources 508B and authenticator node 502B. Examples of the authentication factors (e.g., the values of which are encoded in encoded authentication factor values 508A and/or 508B) may include any combination of a fingerprint, passphrase, RFID, voice print, iris recognition, facial recognition, electrocardiogram (ECG) or heart rate, hand geometry, and/or foot geometry.

In some examples, authentication sources 508A associated with entity 510A or another computing device associated with entity 510A may perform one-way encoding of authentication factor values collected from entity 510A to generate encoded authentication factor values 518A. Similarly, authentication sources 508B or another computing device may perform one-way encoding of authentication factor values collected by authentication sources 508B from entity 510A to generate encoded authentication factor values 518B. That is, authentication sources 508A associated with entity 510A or another computing device associated with entity 510A may perform a one-way hashing (first-layer) of authentication factor values to generate encoded authentication factor values 518A, and may send encoded authentication factor values 518A to authenticator node 502B associated with entity 510B. Similarly, authentication sources 508B associated with entity 510B or another computing device associated with entity 510B may perform a one-way hashing (first-layer) of authentication factor values to generate encoded authentication factor values 518B, and may send encoded authentication factor values 518B to authenticator node 502B associated with entity 510B. In some examples, authentication sources 508A associated with entity 510A or another computing device associated with entity 510A may perform rounding and combining of authentication factor values and may perform the first-layer hashing of the rounded and combined authentication factor values to generate encoded authentication factor values 518A, and authentication sources 508B associated with entity 510B or another computing device associated with entity 510B may perform rounding and combining of authentication factor values and may perform the first-layer hashing of the rounded and combined authentication factor values to generate encoded authentication factor values 518B.

Authentication sources 508A associated with entity 510A or another computing device associated with entity 510A may send encoded authentication factor values 518A to authenticator node 502B via a secure communications channel, such as a wireless communication channel that implements Secure Socket Layer or other communication encryption techniques. Similarly, authentication sources 508B associated with entity 510B or another computing device associated with entity 510B may send encoded authentication factor values 518B to authenticator node 502B via a secure communications channel, such as a wireless communication channel that implements Secure Socket Layer or other communication encryption techniques.

Authenticator node 502B may, in response to receiving encoded authentication factor values 518A and 518B, perform a second-layer one-way hashing of encoded authentication factor values 518A and 518B. Authenticator node 502B may perform the hashing using the same hashing technique as the hashing technique performed to generate encoded authentication factor values 518A and 518B or may perform a different hashing technique.

Because the trusted authentication information are also encoded in entity credentials 504A using two layers of hashing, the two layers of hashing of encoded authentication factor values 518A and 518B may produce authentication data that authenticator node 502B can directly compare against the trusted authentication information are also encoded in entity credentials 504A to authenticate entity 510A as a friendly party. In addition, because each layer of the two layers of hashing are separately performed by devices under the control of respective entities 510A and 510B, the two layers of hashing may produce authentication data that can be compared against the trusted authentication information are also encoded in entity credentials 504A only if both entities 510A and 510B know the hashing algorithms used to encode the trusted authentication information in entity credentials 504A. This may provide further security that may prevent malicious entities from being able to be successfully authenticated by entity 510B as friendly entities.

Authenticator node 502B may compare the authentication data generated via hashing encoded authentication factor values 518A and 518B with the trusted authentication information associated with entity 510A encoded in entity credentials 504A to determine whether entity 510A is a friendly entity to entity 510B. If authenticator node 502B determines that the authentication data generated via the two layers of hashing matches the trusted authentication information in entity credentials 504A, authenticator node 502B may determine that entity 510A is a friendly entity to entity 510B. Similarly, if authenticator node 502B determines that the authentication data generated via the two layers of hashing does not match the trusted authentication information in entity credentials 504A, authenticator node 502B may determine that entity 510A is not a friendly entity to entity 510B.

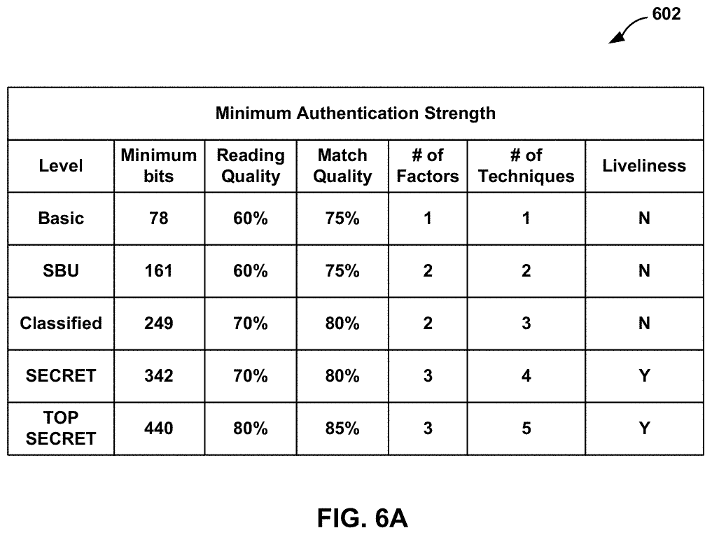

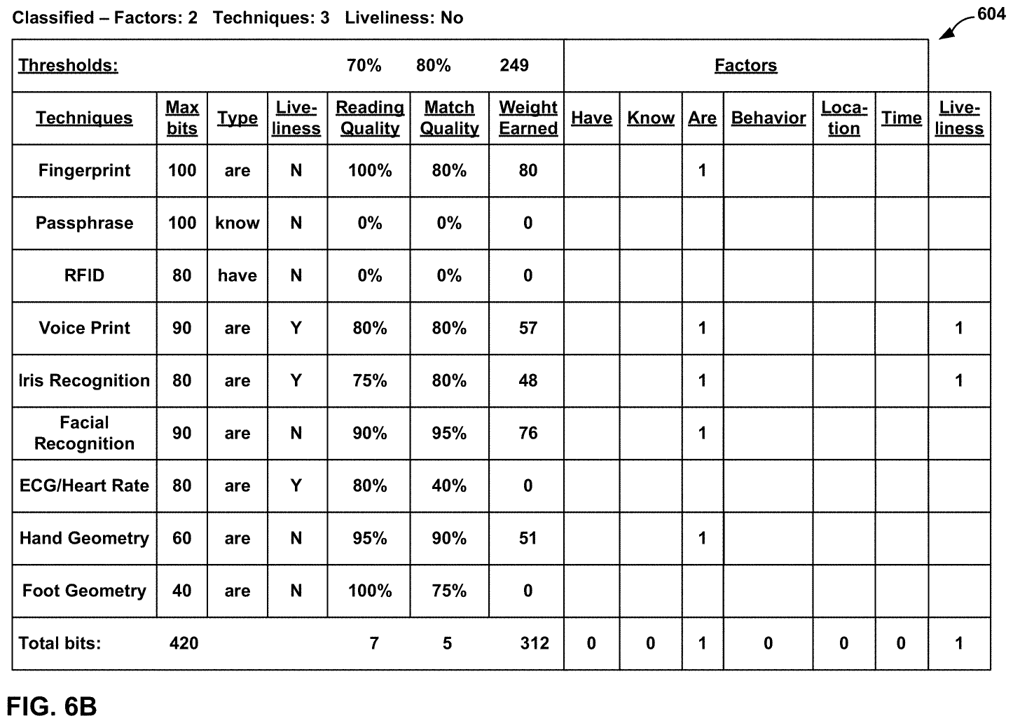

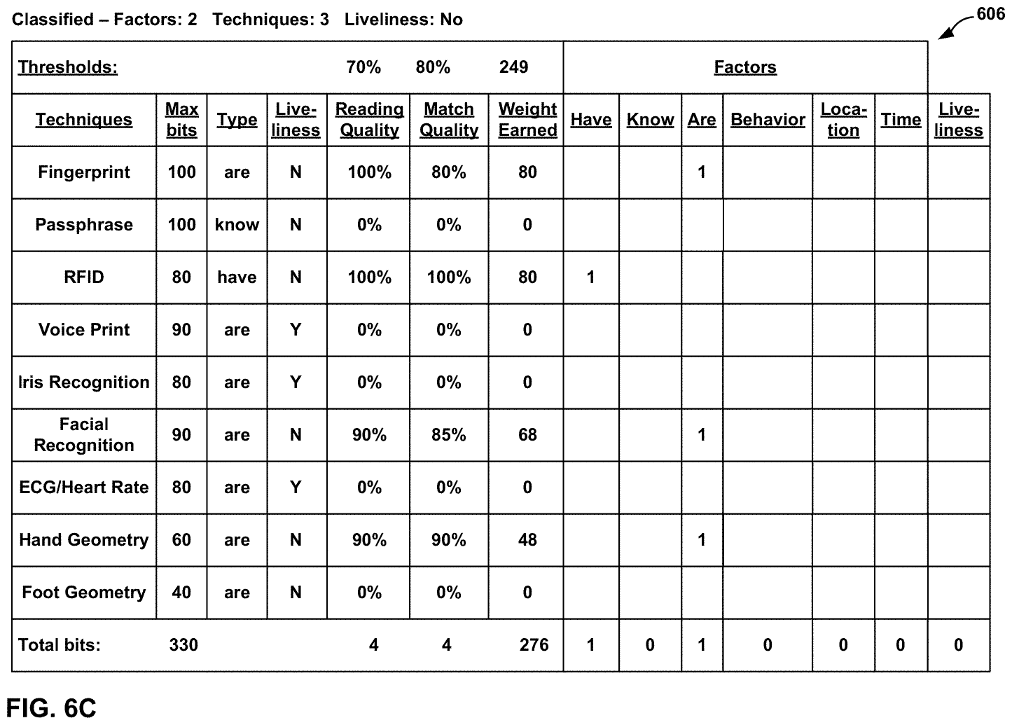

Authenticator node 502B may determine whether the authentication data generated via the two layers of hashing match the trusted authentication information in entity credentials 504A using any suitable technique. For example, authenticator node 502B may determine whether the authentication data generated via the two layers of hashing match the trusted authentication information in entity credentials 504A using the Scalable Authentication that is Flexible and Dynamic (SAFe-D) technique, as described in more detail below with respect to FIGS. 6A-6C. Although not illustrated in the figures, entity 510A may similarly attempt to authenticate entity 510B as a friendly entity using the same techniques as described in FIG. 5B.

FIG. 6A-6C illustrates examples of performing scalable and dynamic authentication using many factors, in accordance with aspects of the disclosure. Such scalable and dynamic authentication is referred to Scalable Authentication that is Flexible and Dynamic (SAFe-D). The techniques of this disclosure may perform SAFe-D for many factors using any combination of the following techniques:
1. combine multiple (e.g., from 3 to over 100) factors and techniques:
   a. factors (authentication categories): something you are, know, have, do (e.g., behavior/role), location, time, and liveness [NOTE: liveness is not an “authentication factor”, but a factor to prove a subject is alive and reacts in real-time];
   b. techniques: many techniques exist within each factor, e.g., all biometric techniques are “something you are”; “something you know” includes: multiple passwords, and PINs, etc.; and combinations such as “something you know”+time (e.g., different passwords for different times of day or duress, etc.), and the like;
2. assign a “weight” to each factor/technique (e.g., in bits);
3. create a single authentication value from factors/techniques and sensor reading quality:
   a. pass/fail thresholds vary depending on the level of assuredness needed (e.g., physical access, logical access, classification levels, personal identifiable information, secret but unclassified, etc.;
   b. bits increase/decrease with sensor reading quality (with threshold cutoffs);
   c. liveness can increase/decrease value, be required or not be required, etc.;
   d. flags and error checks can increase/decrease value:
      i. full 100% match (e.g., no extra entries and/or no unused entries) may indicate a copy or a replay attack;
      ii. other known attack checks;
   e. duress capabilities; both passwords and biometrics (e.g., using the left pinky finger to provide a fingerprint may be a duress signal indicative of duress by the person providing the fingerprint);
4. ability to combine local sensors and remote sensors on different platforms (e.g., cameras to measure gait, RFID tag reader from other users, etc.):
   a. not every entity may have identification sensors;
   b. not every entity may have end user devices and/or a tactical display or interface;
   c. not every entity may have every sensor;
   d. only a few entities may have SSUBIA enabled devices;
   e. not all entities may have radios or satellite communications;
   f. entities may move in and out of range of sensors.

As shown in FIG. 6A, table 602 illustrates an example of the minimum authentication strength for different levels of secrecy, where the example secrecy levels may include basic, secret but unclassified (SBU), classified, secret, and top secret. For each level of secrecy, table 602 specifies a minimum number of bits, a minimum reading quality, a minimum match quality, the minimum number of factors, the minimum number of techniques, and whether liveliness is required.

When an authenticator node (such as authenticator node 102 shown in FIG. 1) attempts to authenticate an entity as a trusted entity, the authenticator node may compare the values of authentication factors of entity against the trusted authentication information encoded in entity credentials associated with the entity and may determine, based on the comparison, information regarding the comparison, such as according to table 602, in order to determine whether the entity is a trusted entity. For example, given an authenticator node with one of the example secrecy levels shown in table 602, the authenticator node may determine whether the values of authentication factors of entity has the minimum number of bits associated with the secrecy level and the minimum reading quality associated with the secrecy level. The authenticator node may also determine whether the match quality of matches between the values of authentication factors of the entity and the trusted authentication information encoded in entity credentials meet the minimum match quality associated with the secrecy level, whether the number of factors in the values of authentication factors of the entity meet the minimum number of factors, whether the number of techniques in the values of authentication factors of the entity meet the minimum number of techniques, and whether the values of authentication factors of the entity meet the liveliness requirements. The authenticator node associated with a given secrecy level may therefore authenticate an entity as a trusted entity if the values of authentication factors of the entity meet each of the categories associated with the secrecy level as set out in table 602.

As shown in FIG. 6B, table 604 illustrates an example of the results of performing scalable and dynamic authentication using many factors to authenticate an entity at a Classified level of secrecy. For example, table 604 may be an example of the results of authenticator node 102 shown in FIG. 1 to authenticate entity 110 shown inf FIG. 1. As shown in table 604, entity 110 may provide authentication factors 106 using a variety of different techniques: fingerprint, passphrase, RFID, voice print, iris recognition, facial recognition, electrocardiogram (ECG) or heart rate, hand geometry, and/or foot geometry. As such, in the example of FIG. 6B, each authentication factor may have values from multiple techniques.

Each of the different techniques may be associated with a maximum number of bits, which may be the number of bits to encode the readings of each of the techniques. Each of the different techniques may have a type of Factor, which may be one or more of something you are, something you know, something you have, something you do (or a behavior), somewhere you are, or time of day. Some of the different techniques, such as voice print, iris recognition, and ECG/heart rate may be liveliness indicators.

Authenticator node 102 may determine the reading quality of each of the techniques and the match quality of the techniques. The reading quality of a technique may be a value, such as from 0% to 100%, that may be associated with, for example, the amount of noise in the reading, the number of minutiae in the reading (e.g., for fingerprints), the fidelity of the reading, the utility of the reading for authenticating entity 110, and the like. The match quality of a technique may be a value, such as from 0% to 100%, that may correspond to how well the reading of the technique matches a corresponding authenticated technique (e.g., as encoded in trusted authentication information 112.

As illustrated in table 602, at the Classified secrecy level, the minimum reading quality is 70% and the minimum match quality is 80%. As such, any techniques in table 604 that do not meet the minimum reading quality or the minimum match quality are not used by authenticator node 102 for the purposes of authenticating entity 110. Authenticator node 102 may determine, for each technique, a weight, which may be a value between 0 and 100, that corresponds to the reading quality and the match quality associated with the technique. In the example of FIG. 6B, because only fingerprint, voice print, iris recognition, facial recognition, and hand geometry meet both the minimum reading quality of 70% and the minimum match quality of 80%, only those five techniques are valid, meaning they have a non-zero weight and are used for the purposes of authenticating entity 110, and the remaining techniques may each have a weight of 0% and may be disregarded for the purposes of authenticating entity 110.

Authenticator node 102 may determine whether the valid techniques each having a non-zero weight together meet the requirements of the Classified secrecy level. The total weight (number of bits) of the valid techniques sum up to 312, which is greater than the minimum bits of 249 specified in table 602 for the Classified secrecy level. The valid techniques include five techniques, which is greater than the minimum of two techniques specified in table 602 for the Classified secrecy level. However, the remaining five techniques are only associated with a single factor of “something you are” out of the factors of something you are, something you know, something you have, something you do (or a behavior), somewhere you are, location, and time of day, which is fewer than the minimum of two factors specified in table 602 for the Classified secrecy level. As such, authenticator node 102 may not be able to successfully authenticate entity 110 as a trusted entity in the example of FIG. 6B. Note that liveness may not be an “authentication factor” per se, but may be a factor to prove a subject is alive and reacts in real-time.

As shown in FIG. 6C, table 606 illustrates another example of the results of performing scalable and dynamic authentication using many factors to authenticate an entity at a Classified level of secrecy. For example, table 604 may be an example of the results of authenticator node 102 shown in FIG. 1 to authenticate entity 110 shown inf FIG. 1. As shown in table 606, entity 110 may provide authentication factors 106 using a variety of different techniques: fingerprint, RFID, facial recognition, and hand geometry.

Each of the different techniques may be associated with a maximum number of bits, which may be the number of bits to encode the readings of each of the techniques. Each of the different techniques may have a type of Factor, which may be one or more of something you are, something you know, something you have, something you do (or a behavior), somewhere you are, or time of day. Some of the different techniques, such as voice print, iris recognition, and ECG/heart rate may be liveliness indicators.

Authenticator node 102 may determine the reading quality of each of the techniques and the match quality of the techniques. The reading quality of a technique may be a value, such as from 0% to 100%, that may be associated with, for example, the amount of noise in the reading, the number of minutiae in the reading (e.g., for fingerprints), the fidelity of the reading, the utility of the reading for authenticating entity 110, and the like. The match quality of a technique may be a value, such as from 0% to 100%, that may correspond to how well the reading of the technique matches a corresponding authenticated technique (e.g., as encoded in trusted authentication information 112.

As illustrated in table 602, at the Classified secrecy level, the minimum reading quality is 70% and the minimum match quality is 80%. As such, any techniques in table 606 that do not meet the minimum reading quality or the minimum match quality are not used by authenticator node 102 for the purposes of authenticating entity 110. Authenticator node 102 may determine, for each technique, a weight, which may be a value between 0 and 100, that corresponds to the reading quality and the match quality associated with the technique. In the example of FIG. 6C, four techniques meet both the minimum reading quality of 70% and the minimum match quality of 80%, only those four techniques are valid, meaning they have a non-zero weight and are used for the purposes of authenticating entity 110, and the remaining techniques may each have a weight of 0% and may be disregarded for the purposes of authenticating entity 110.

Authenticator node 102 may determine whether the valid techniques each having a non-zero weight together meet the requirements of the Classified secrecy level. The total weight (number of bits) of the valid techniques sum up to 276, which is greater than the minimum bits of 249 specified in table 602 for the Classified secrecy level. The valid techniques include four techniques, which is greater than the minimum of two techniques specified in table 602 for the Classified secrecy level. Furthermore, the valid four techniques are associated with two factors: “something you have” and “something you are”, which meets the minimum of two factors specified in table 602 for the Classified secrecy level. As such, authenticator node 102 may be able to successfully authenticate entity 110 as a trusted entity in the example of FIG. 6C. For example, this technique may be used in the example illustrated in FIGS. 5A and 5B to authenticate entity 510A as a trusted entity by comparing values of authentication factors collected from entity 510A with the trusted information encoded in entity credentials 504A.

As discussed above, SSUBIA may support duress codes, which are covert distress signals used by an individual who is being coerced by one or more hostile persons, used to warn others or trigger an alarm when they are being forced to do something against their will. Typically, the warning is given via some innocuous signal embedded in normal communication, (code-word or phrase). Alternatively, the signal may be incorporated into the authentication process itself, typically in the form of a panic password, distress password, or duress PIN that is distinct from the user's normal password or PIN. For example, a user may, instead of entering the user's password or PIN at an authenticator node for the purposes of authenticating the user, enter a duress code in the form of a panic password, distress password, or duress PIN that is distinct from the user's normal password or PIN.

SSUBIA also supports duress biometrics and other duress techniques (e.g., use a specific fingerprint for duress, or tie it to a time of day, or close one eye during a facial scan, or use different password or pin, or some other form). The triggering of these duress biometrics may be meant to be “hidden” or at least not obvious. As such, the duress biometrics may be embedded within the single credential strength value (e.g., using a defined bitmask or some alternative technique).

In some examples, a Many-Factor Adaptive Touchless Authentication Solution (MATAS) may utilize the techniques of SSUBIA described in this disclosure to provide techniques for performing touch-free authentication for sites and systems while integrating with existing hardware and systems. Current identity, credential, and access management (ICAM) systems may require handling physical components like Common Access Cards (CACs), card readers, keypads, fingerprint scanners, and the like in order for a user to authenticate themselves using an ICAM system. Multiple people touching these devices increases exposure to disease. A Pandemic Entry and Automated Control Environment may provide authentication and physical access to buildings and resources while eliminating disease and germ contamination and transfer among users through access control systems and hardware.

MATAS may provide adaptive authentication using a hybrid of CAC with PIN, combined with using biometric data such as existing and learned facial patterns, body-description matching (e.g., from a PDF417 barcode on a CAC or on a driver's license), voiceprints, and the like to perform authentication. MATAS may also integrate mobile phones and additional authentication tokens such as digital bracelets, smart watches, RFID dog tags, and the like, into touchless multi-factor authentication paradigms. MATAS may also add additional touchless biometrics and factors to CACs, and may expand multi-factor and dynamic authentication to enable many-factor adaptive authentication.

The authentication industry universally recognizes three primary authentication factors: something you know (PIN, password, etc.); something you have (CAC, USB token, RFID, etc.); and something you are (fingerprint, facial recognition, etc.). More recently, additional factors have emerged, such as: somewhere you are (location at a given moment, physically on-site, at a specific PC, etc.); something you do (e.g., behaviors, gestures, voice, etc.), liveness (e.g., is the subject alive?), and time (e.g., controlling user logins or accesses based on time of day). Within each authentication factor there may be multiple techniques (e.g., the numerous biometric techniques such as fingerprint, voiceprint, gait, iris scan, etc.).

Single-factor authentication may often be easily thwarted through spoofing. SSUBIA and MATAS are dynamic and adaptive methods for incorporating many authentication factors and techniques that significantly increase resistance to spoofing and resistance to false authentications. SSUBIA and MATAS may adaptively require an increase in the number of factors and/or techniques if a user is attempting to access higher security levels (SECRET, TOP SECRET, etc.). For example, CACs may contain a PDF417 barcode that encodes a person's description (e.g., height weight, hair color, eye color, etc.) that can be scanned using cameras. Cameras can capture face images, eye color, height, and these can be used with existing metadata to do both facial recognition and general description matching. In addition, a PIN is encoded on a CAC that could be entered verbally and decoded for comparison. Some CACs also contain RFID chips that serve as an additional identifier.

In some examples, an authentication system for a facility in MATAS may ask for a keyed entry (non-touchless entry) of a PIN on the first access after MATAS installation, and then prompt for a new voiceprint or voice password that could be encoded and saved locally (i.e., only on computing systems in the facility) and be used as a verbal PIN alternative for a period of time. In other examples, MATAS may use biometric identifiers embedded within mobile devices for short-range wireless remote or proxy authentication, much like how a bank website uses fingerprint for account access. In some examples, ear prints/images can be used like fingerprints for authentication, and can be captured using cameras without touch. Ear prints/images can be recorded on-the-fly and cached for future use to augment users' metadata info. In some examples, heart rates and breathing can be sensed by infrared cameras and can be used as a liveness indicator. In some examples, MATAS can perform multi-layered facial or body shape recognition using visual-spectrum, infrared, or ultraviolet cameras.

In some examples, MATAS may use biometric hashing and/or encryption to securely store this data for one-to-one comparisons against known pre-recorded metadata. In some examples, MATAS may combine multiple authentication factors to derive a single authentication value. MATAS may aggregate authentication data from multiple sources into a composite weighting of each available authentication input, such as using the techniques illustrated throughout this disclosure. The weight assigned may be defined by a strength for each authenticator technique, and the final value may be required to have a minimum strength in order for successful user authentication.

For example, a user may attempt to access a facility having a security level of SECRET, where the threshold for authentication and entry is 400. If the authentication values of the user total a value of 396, the user may be denied entry to the facility. However, if the user attempts to pass the facility's front gate, where the threshold for authentication and entry is 250, then the user may be granted access to the facility. In another technique, MATAS may compare the average authentication quality (92% in this example) with a threshold minimum quality, such as 75% or 85%. The thresholds can be adjusted for each access-controlled door or computer system in a facility.

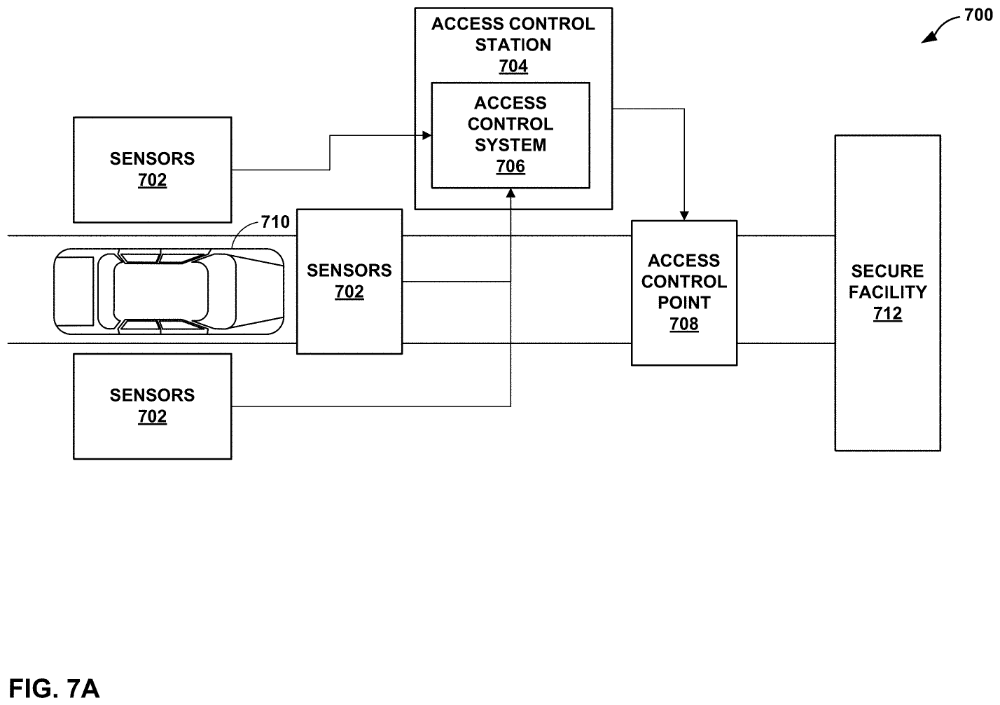

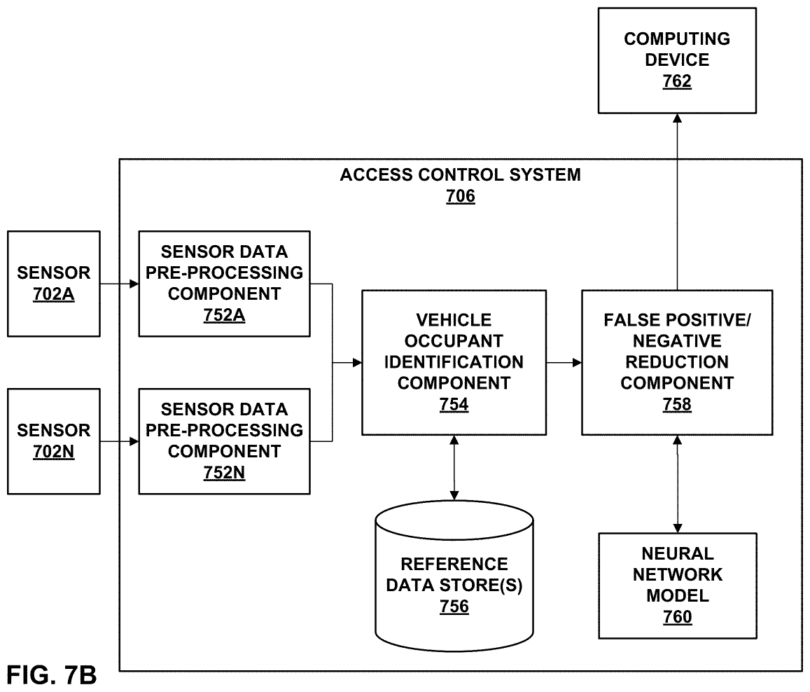

FIGS. 7A and 7B illustrate a real-time drive-thru passenger identification camera system implemented using the techniques of SSUBIA and MATAS, in accordance with aspects of this disclosure.

Existing Automated Installation Entry (AIE) systems may allow expedited vehicle traffic flow for pre-approved users when going through Access Control Points (ACPs) or entry gates. These systems may be mostly CAC-based, where a user stops, scans their CAC, then enters their PIN. Entry is usually observed by a guard. If multiple people are in the vehicle, the guard may ask to see each person's CAC to verify the identity of each person. When people arrive at these gates without a CAC or pre-approval, the automated systems do not work, therefore potentially forcing the guards to manually check the occupants of the vehicle.

A real-time passenger identification camera system may use cars, license plates, behaviors (e.g., arrival times, carpool groups, etc.) to perform real-time identification and authentication of drivers, passenger(s) and vehicles carrying the passenger(s). The system may combine multiple cameras across multiple spectrums and/or other sensors to address different weather and lighting conditions, identify multiple occupants in a vehicle from multiple camera angles, visually read CAC, mobile devices, barcodes, and QR codes for novel challenges and responses for in-motion authentications, and may learn user patterns (e.g., carpools, make/model, license plate number, etc.) to validate normal situations and flag anomalous situations.

The real-time passenger identification camera system according to the techniques of this disclosure may allow vehicle, driver, and passengers to be detected, identified, and validated in an automated fashion to improve throughput of gate entry, without having to stop every vehicle. The real-time passenger identification camera system may use biometrics and cameras that work under a variety of different lighting conditions (e.g., day and night) and/or any a variety of different weather condition (e.g., sunny, foggy, rainy, etc.). The real-time passenger identification camera system may also be able to detect and identify drivers and passengers. The real-time passenger identification camera system may also be used to report security alerts and anomalies.

The real-time passenger identification camera system may use biometrics to identify drivers and passengers, as well as enable touchless on-the-move CAC reading and PIN entry, matching registered vehicles to drivers, and validating license plates and other identifying human and vehicle traits to identify drivers, carpool occupants, and contractors needing base entry during all weather conditions. The real-time passenger identification camera system may use a system of cameras, image processing, and machine learning to capture images of passengers in approaching vehicles and authenticate them with 100% accuracy in real time.

In the example of FIG. 7A, real-time passenger identification camera system 700 may include access control system 706 that identifiers drivers and passengers of vehicles using sensors 702 to govern access control point 708 of secure facility 712.

Sensors 702 may include any suitable sensors for identifying drivers and passengers of vehicles as well as for identifying any other suitable characteristics of the passengers and/or of vehicle 710. In some examples, sensors 702 may include cameras that cover different spectrums and functions, such as any combination of normal visible spectrum, night vision or infrared, distance/3D, light detection and ranging (LIDAR), time-flight, and/or ultraviolet. The cameras may have different capabilities to collect facial images in normal light, low light, no light, and may also detect 3D features using laser scanning or Time-of-Flight sensors. These images can be used for facial recognition separately or in combination. The sets of cameras may be situated to cover multiple lanes and all sides of the vehicles entering the gate to identify drivers and passengers.

Sensors 702 may be located so that as vehicle 710 approaches access control point 708, one or more sets of sensors 702 may face the front of vehicle 710 to capture images of the front of vehicle 710, including capturing images of the front fascia of vehicle 710, the front license plate of vehicle 710, people and objects behind the windshield of vehicle 710, and the like, to identify drivers and passengers of vehicle 710. Sensors 702 may also be located so that as vehicle 710 approaches access control point 708, one or more sets of sensors 702 may face each side of vehicle 710 to capture images of people and objects through the side windows on each side of vehicle 710 to identify drivers and passengers of vehicle 710. Vehicle 710 may not have to come to a stop in order for sensors 702 to capture images and other data of vehicles 710 and of passengers of vehicle 710. Instead, vehicle 710 may continue to move as sensors 702 capture such data.

Passengers of vehicle 710 may situate identification documents, such as CACs, on the dashes of vehicles, or may hold the identification documents in the window of the vehicle in view of the cameras of sensors 702 to allow for scanning or capture of the identification documents (e.g., the CACs and the PDF417 barcodes) by the cameras of sensors 702. That is, one or more sensors 702 may capture images of the identification documents of each of the passengers of vehicle 710, and may transmit indications of the captured images to access control point 708.

Passengers of vehicles 710 may also hold or otherwise situate any other objects that may be used by access control system 706 to identify the passengers of vehicle 710. In some examples, mobile computing devices of each of passengers of vehicle 710, such as the smart phones of occupants of vehicle 710 may communicate with access control system 706, such as via wireless communications (e.g., cellular data, Wi-Fi, etc.) to receive a one-time key. Each passenger may input a password or PIN in each of their mobile computing devices, such as into an app used for entering secure facility 712, and each of the mobile computing devices may generate encoded data, such as a one-time bar code, a one-time QR code, and the like, based on the inputted password or PIN and the one-time key. The mobile computing device of each of the passengers of vehicle 710 may output, for display at the mobile computing device's display, the encoded data generated by the mobile computing device. Each passenger of vehicle 710 may each hold or situate the display of their mobile computing device in view of the cameras of sensors 702 to allow for scanning or capture of the displayed encoded data by the cameras of sensors 702, and sensors 702 may transmit indications of the captured images to access control system 706.

Access control system 706 may receive, from sensors 702, sensor data, such as images, video, audio, biometric information, or any other data captured by sensors 702, and may perform authentication of vehicle 710 and/or passengers of vehicle 710 based at least in part on the sensor data, such as by using the techniques of SSUBIA described in this disclosure and/or the techniques described with respect to FIG.7B. If access control system 706 determines that each of the passengers of vehicle 710 is authorized to access secure facility 712, access control system 706 may output an indication that vehicle 710 is authorized to access secure facility 712.

For example, access control system 706 may communicate with access control point 708, which may be a door, a gate, and the like, to send access control point 708 an indication that vehicle 710 is authorized to access secure facility 712 that causes access control point 708 to allow vehicle 710 to enter secure facility 712, such as by opening the gate of access control point 708. In another example, access control system 706 may send an indication that vehicle 710 is authorized to access secure facility 712 to a computing device used by a user, such as a guard in access control station 704. The computing device used by the user may, in response, communicate with access control point 708 to send access control point 708 an indication that vehicle 710 is authorized to access secure facility 712 that causes access control point 708 to allow vehicle 710 to enter secure facility 712. In another example, access control system 706 may output, for display at a display device an indication that vehicle 710 is authorized to access secure facility 712, and a user, such as a guard in access control station 704, may, in response to viewing the indication that vehicle 710 is authorized to access secure facility 712, operate access control point 708 to allow vehicle 710 to enter secure facility 712.

In some examples, real-time passenger identification camera system 700 may integrate any combination of biometrics, user identifications, and machine learning to provide vehicle occupant identification within slow moving vehicles (e.g., vehicle 710). Such identification data are then logged and provided to the guard on a computer interface (e.g., a display operably coupled to access control system 706) in access control station 704 (e.g., a guard shack) or a computing device communicably coupled with access control station 704, and can be used to automatically trigger opening of access control point 708 or can cause the guard to manually trigger opening of access control point 708.

In some examples, access control system 706 may pre-process and combine image data captured by multiple cameras of sensors 702, and may use such image data for identification and lookup using new and existing reference databases. Such image data may include all images from the cameras of sensors 702, including CACs, PDF417 barcodes, QR codes, facial images, license plates, vehicles and colors, and the like. In some examples, real-time passenger identification camera system 700 may also include weight sensors in sensors 702 to collect and judge weight changes to identify discrepancies and anomalies that may indicate large devices on-board vehicle 710 (e.g., explosive devices or threats). Once all the images are analyzed, faces are identified, and components are decoded (e.g., barcodes, QR codes), such data can be passed to a machine learning engine to validate against previously recorded and learned patterns for the users (e.g., carpools, normal entry times, etc.). This may be used to help identify false positives and false negatives. The results may be logged and sent to the guard's interface screen to allow the system or guard to decide whether to open access control point 708.

As shown in FIG. 7B, access control system 706 may include sensor data pre-processing components 752A-752N (“sensor data pre-processing components 752”), vehicle occupant identification component 754, one or more reference data stores 756, false positive/negative reduction component 758, and neural network model 760. One or more reference data stores 756 may be any suitable data store, such as a database, a repository, a journal, and the like, stored on computer-readable storage medium, such as a disk, in memory, and the like. Sensor data pre-processing components 752, vehicle occupant identification component 754, false positive/negative reduction component 758, and neural network model 760 may perform operations described herein using software, hardware, firmware, or a mixture of hardware, software, and firmware residing in and/or executing access control system 706 to perform functions described herein. Access control system 706 may execute sensor data pre-processing components 752, vehicle occupant identification component 754, false positive/negative reduction component 758, and neural network model 760 with multiple processors or multiple devices, as virtual machines executing on underlying hardware, as one or more services of an operating system or computing platform, and/or as one or more executable programs at an application layer of a computing platform of access control system 706.

Sensor data pre-processing components 752 may receive sensor data from sensors 702A-702N to perform sensor data pre-processing. Such sensor data may include images, audio, video, biometric information, weight information, or any other suitable information captured by sensors 702 associated with vehicle 710. For example, sensor data pre-processing components 752 may perform noise reduction operations, rotation operations (e.g., of image data), or any other suitable processing operations on the sensor data.

Vehicle occupant identification component 754 may receive the sensor data processed by sensor data pre-processing components 752 to determine the identity of each occupant of vehicle 710 and to determine whether each occupant of vehicle 710 is an authorized personnel, such as whether each occupant is authorized to enter secure facility 712. For example, to determine the identity of an occupant, if a CAC or another identification document of the occupant contains a PDF 417 barcode that encodes trusted authentication information associated with the occupant, vehicle occupant identification component 754 may be able to decode the trusted authentication information from one or more images of the CAC of the occupant captured by sensors 702. Vehicle occupant identification component 754 may compare various authentication factors associated with the occupant in the images captured by sensors 702 with the trusted authentication information, such as by using the SSUBIA techniques described in this disclosure, to identify the occupant. In this way, an identification document of an occupant may act as the entity credentials for the occupant.

In some examples, vehicle occupant identification component 754 may combine the techniques of SSUBIA described in this disclosure with additional authentication techniques to determine the identity of each occupant of vehicle 710. For example, if the images captured by sensors 702 include images of an encoded password or PIN, such as a QR code displayed by the occupant's smart phone, vehicle occupant identification component 754 may be able to decode the password or PIN from the captured image of the QR code to authenticate the password or PIN and to determine, based on authentication of the password or PIN, identify the occupant and/or determine whether the occupant is authorized to enter secure facility 712.

In some examples, if the images captured by sensors 702 include images of the faces of the occupants of vehicle 710, vehicle occupant identification component 754 may perform facial recognition to identify the occupants of vehicle 710, such as by using information stored in one or more reference data stores 756, such as reference images, reference data, names, photos, and the like. Similarly, vehicle occupant identification component 754 may use the data stored in one or more reference data stores 756 to validate other features in the sensor data captured by sensors 702 to identify the occupants of vehicle 710, such as to match license plate number of vehicle 710 with an identity of the owner of the vehicle having that license plate number, and/or to match other identifying features of vehicle 710 such as color, make, model, etc. with information in one or more reference data stores 756 to determine the occupants of vehicle 710.

Vehicle occupant identification component 754 may determine an identity of each occupant and determine a confidence score for each occupant that indicates the level of confidence that vehicle occupant identification component 754 has correctly determined the occupant. Vehicle occupant identification component 754 may send the determined identity of each occupant, the confidence score associated with each confidence store, as well as other identifying information determined by vehicle occupant identification component 754, such as the vehicle type of vehicle 710, time of day information, the encoded passwords (e.g., QR codes) captured by sensors 702, the indication of the trusted information (e.g., the PDF417 bar codes) encoded in the identifying documents captured by sensors 702, and the like to false positive/negative reduction component 758.

False positive/negative reduction component 758 may use the information received from vehicle occupant identification component 754 to reduce false positives and/or false negatives in the identification of the occupants of vehicle 710. Specifically, false positive/negative reduction component 758 may validate the information received from vehicle occupant identification component 754 against previously recorded and learned information and patterns from vehicles that have previously attempted to enter secure facility 712 to determine whether access control system 706 has correctly identified vehicle 710 as being authorized or unauthorized to enter secure facility 712. For example, false positive/negative reduction component 758 may use machine learning, such as neural network model 760 to determine whether access control system 706 has correctly identified vehicle 710 as being authorized or unauthorized to enter secure facility 712. False positive/negative reduction component 758 may therefore determine, based on the information received from vehicle occupant identification component 754 and neural network model 760, the identity of the occupants of vehicle 710 and whether vehicle 710 is verified as being allowed to enter secure facility 712.

In some examples, false positive/negative reduction component 758 may send indications of the identity of the occupants of vehicle 710 and whether vehicle 710 is verified as being allowed to enter secure facility 712 to a computing device used by a guard of secure facility 712 to alert the guard as to the identity of the occupants of vehicle 710 and whether vehicle 710 is verified as being allowed to enter secure facility 712. The guard may use such information to determine whether to open access control point 708 to allow vehicle 710 to enter secure facility 712.

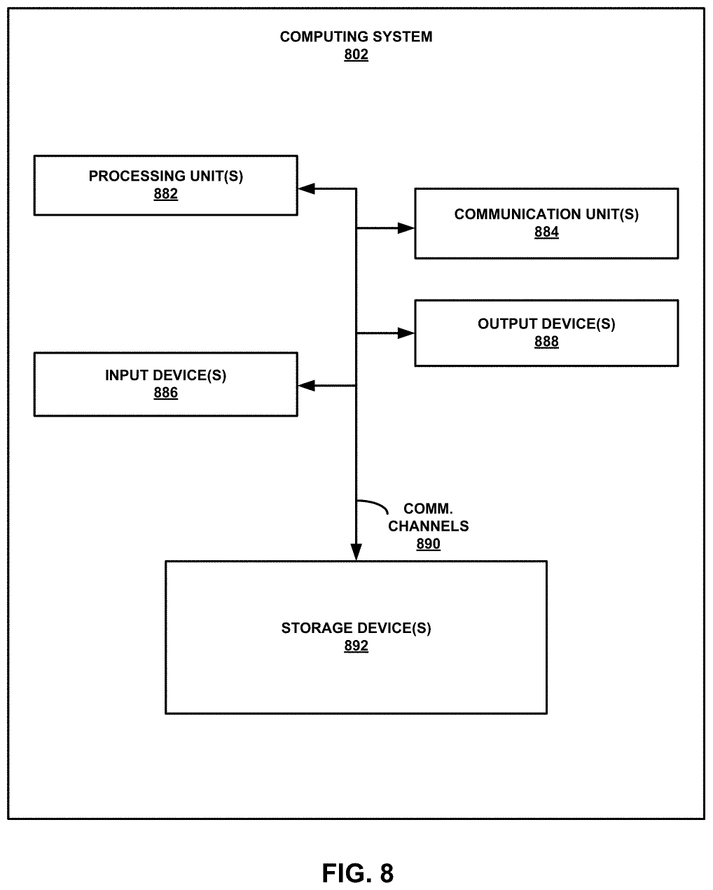

FIG. 8 is a block diagram illustrating further details of an example computing device 802, in accordance with one or more aspects of the present disclosure. Computing device 802 may be an example of any computing device and any computing system described throughout this disclosure, such as authenticator node 102 of FIG. 1, enrollment system 130 of FIG. 1, certificate authority 120 of FIG. 1, one or more authentication sources 108 of FIG. 1, or any other computing device or computing system described in this disclosure. FIG. 8 illustrates only one particular example of computing device 802, and many other examples of computing device 802 may be used in other instances and may include a subset of the components shown, or may include additional components not shown, in FIG.8.

As shown in the example of FIG. 8, computing device 802 includes one or more processing units 882, one or more input devices 886, one or more communication units 884, one or more output devices 888, and one or more storage devices 892.

Communication channels 890 may interconnect each of the components 882, 884, 886, 888, and 892 for inter-component communications (physically, communicatively, and/or operatively). In some examples, communication channels 890 may include a system bus, a network connection, an inter-process communication data structure, or any other method for communicating data between hardware and/or software.

One or more input devices 886 of computing device 802 may receive input. Examples of input are tactile, audio, and video input. More examples of input devices 886 include a presence-sensitive screen, touch-sensitive screen, mouse, keyboard, voice responsive system, video camera, microphone or any other type of device for detecting input from a human or machine.

One or more output devices 888 of computing device 802 may generate output. Examples of output are tactile, audio, and video output. Examples of output devices 888 include a presence-sensitive screen, sound card, video graphics adapter card, speaker, cathode ray tube (CRT) monitor, liquid crystal display (LCD), or any other type of device for generating output to a human or machine. Output devices 888 may include display devices such as cathode ray tube (CRT) monitor, liquid crystal display (LCD), or any other type of device for generating tactile, audio, and/or visual output.

One or more communication units 884 of computing device 802 may communicate with one or more other computing systems or devices via one or more networks by transmitting and/or receiving network signals on the one or more networks. Examples of communication units 884 include a network interface card (e.g., such as an Ethernet card), an optical transceiver, a radio frequency transceiver, or any other type of device that can send and/or receive information, such as through a wired or wireless network. Other examples of communication units 884 may include short wave radios, cellular data radios, wireless Ethernet network radios, as well as universal serial bus (USB) controllers.

One or more storage devices 892 within computing device 802 may store information for processing during operation of computing device 802 (e.g., computing device 802 may store data accessed by one or more modules, processes, applications, or the like during execution at computing device 802). In some examples, storage devices 892 on computing device 802 may be configured for short-term storage of information as volatile memory and therefore not retain stored contents if powered off. Examples of volatile memories include random-access memories (RAM), dynamic random-access memories (DRAM), static random-access memories (SRAM), and other forms of volatile memories known in the art. In some cases, storage devices 892 may include redundant array of independent disks (RAID) configurations and one or more solid-state drives (SSD's).

Storage devices 892, in some examples, also include one or more computer-readable storage media. Storage devices 892 may be configured to store larger amounts of information than volatile memory. Storage devices 892 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 892 may store program instructions and/or data associated with one or more software/firmware elements or modules.

Computing device 802 further includes one or more processing units 882 that may implement functionality and/or execute instructions within computing device 802. For example, processing units 882 may receive and execute instructions stored by storage devices 892 that execute the functionality of the elements and/or modules described herein. These instructions executed by processing units 882 may cause computing device 802 to store information within storage devices 892 during program execution. Processing units 882 may also execute instructions of an operating system to perform one or more operations described herein.

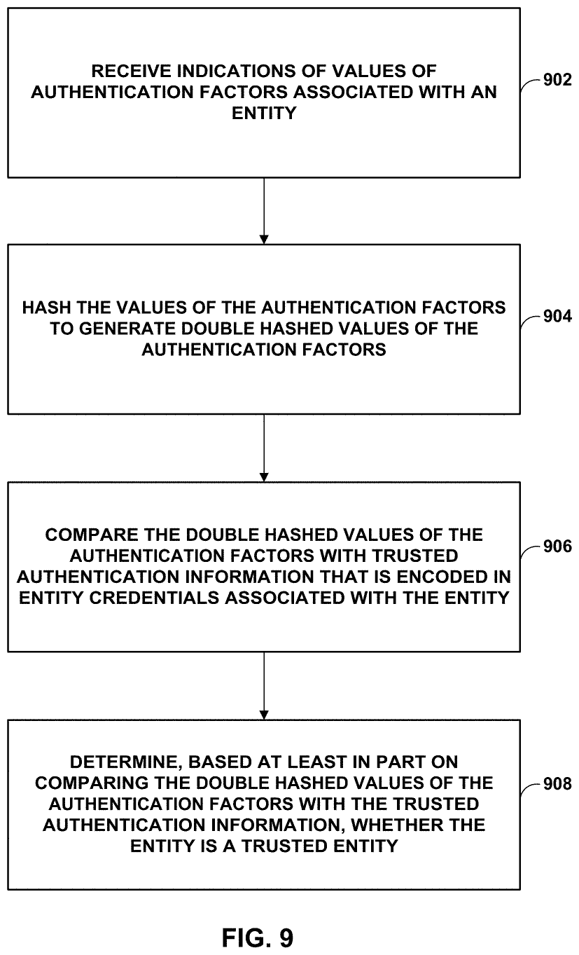

FIG. 9 is a flow diagram illustrating example operations in accordance with one or more aspects of this disclosure. The techniques of FIG. 9 may be performed by one or more processors of a computing device, such as authenticator node 102 of FIG. 1.

As shown in FIG. 9, authenticator node 102 may receive indications of values 117 of authentication factors 106 associated with an entity 110 (902). Authenticator node 102 may perform hashing of values 117 of the authentication factors 106 to generate double hashed values 122 of the authentication factors 106 (904). Authenticator node 102 may compare the double hashed values 122 of the authentication factors 106 with trusted authentication information 112 that is encoded in entity credentials 104 associated with the entity 110 (906). Authenticator node 102 may determine, based at least in part on comparing the double hashed values 122 of the authentication factors 106 with the trusted authentication information 112, whether the entity 110 is a trusted entity (908).

In some examples, an authenticator node 102 may determine, with one or more processors and based at least in part on comparing the hashed values of the authentication factors with trusted values of the trusted authentication information, an authentication value associated with the entity. Moreover, an authenticator node 102 may determine, with one or more processors and based at least in part on the authentication value, whether the entity is a trusted entity.

In some examples, an authenticator node 102 may, in response to determine that the authentication value exceeds the authentication threshold, determining, with one or more processors, that the entity is the trusted entity.

In some examples, an authenticator node 102 may compare, with one or more processors, each hashed value of an authentication factor with a trusted value of the authentication factor in the trusted authentication information to determine the authentication value associated with the entity.

In some examples, an authenticator node 102 may weigh, with one or more processors, the authentication factors.

In some examples, an authenticator node 102 may determine, with one or more processors, that a plurality of techniques in the authentication factors meet a minimum reading quality and a minimum match quality. Moreover, an authenticator node 102 may determine, with one or more processors and for each respective technique of the plurality of techniques, a weight based at least in part on a reading quality of the respective technique and a match quality of the respective technique. Further, an authenticator node 102 may determine, with one or more processors, whether the entity is the trusted entity based at least in part on the plurality of techniques in the authentication factors meet the minimum reading quality and the minimum match quality.

In some examples, an authenticator node 102 may, in response to determine that the hashed value of the authentication factors indicates the duress signal, determining, with one or more processors, that the entity is under duress. Aspects of this disclosure include the following examples.

Example 1: A method includes receiving, by one or more processors of a computing device, indications of hashed values of authentication factors associated with an entity; hashing, by the one or more processors, the hashed values of the authentication factors to generate double hashed values of the authentication factors; comparing, by the one or more processors, the double hashed values of the authentication factors with trusted authentication information that is encoded in entity credentials associated with the entity; and determining, based on comparing the double hashed values of the authentication factors with the trusted authentication information, whether the entity is a trusted entity.

Example 2: The method of example 1, wherein the trusted authentication information includes trusted values of the authentication factors encoded using two layers of hashing.

Example 3: The method of example 2, wherein each of the trusted values of the authentication factors in the trusted authentication information are encoded in the entity credentials by rounding, combining, and the two layers of hashing of a trusted value of the authentication factors.

Example 4: The method of example 3, wherein each of the hashed values of the authentication factors associated with the entity is a value of an authentication factor that has been rounded, combined, and hashed to generate a hashed value of the authentication factor.

Example 5: The method of example 1, wherein determining whether the entity is a trusted entity further comprises: determining, by the one or more processors and based at least in part on comparing the hashed values of the authentication factors with trusted values of the trusted authentication information, an authentication value associated with the entity; and determining, by the one or more processors and based at least in part on the authentication value, whether the entity is a trusted entity.

Example 6: The method of example 5, wherein determining whether the entity is a trusted entity comprises: comparing, by the one or more processors, the authentication value to an authentication threshold associated with a secrecy level the computing device; and in response to determining that the authentication value exceeds the authentication threshold, determining, by the one or more processors, that the entity is the trusted entity.

Example 7: The method of example 5, wherein comparing the hashed values of the authentication factors with the trusted values of the authentication information further comprises: comparing, by the one or more processors, each hashed value of an authentication factor with a trusted value of the authentication factor in the trusted authentication information to determine the authentication value associated with the entity.

Example 8: The method of example 5, wherein comparing the hashed values of the authentication factors with the trusted values of the authentication information further comprises: weighing, by the one or more processors, the authentication factors; and determining, by the one or more processors, the authentication value based at least in part on the weighing of the authentication factors.

Example 9: The method of example 1, wherein determining whether the entity is the trusted entity further comprises: determining, by the one or more processors, that a plurality of techniques in the authentication factors meet a minimum reading quality and a minimum match quality; determining, by the one or more processors and for each respective technique of the plurality of techniques, a weight based at least in part on a reading quality of the respective technique and a match quality of the respective technique; and determining, by the one or more processors, whether the entity is the trusted entity based at least in part on the plurality of techniques in the authentication factors meet the minimum reading quality and the minimum match quality.

Example 10: The method of example 1, wherein the entity includes a person, and wherein the authentication factors include biometric information associated with the entity.

Example 11: The method of example 1, wherein the entity includes a device, and wherein the authentication factors include machine data produced by the device.

Example 12: The method of example 1, wherein a value of the authentication factors is indicative of a duress signal, and wherein determining whether the entity is the trusted entity further comprises: determining that a hashed value of the authentication factors indicates a duress signal; and in response to determining that the hashed value of the authentication factors indicates the duress signal, determining, by the one or more processors, that the entity is under duress.

Example 13: The method of example 1, wherein: the computing device is part of a touchless authentication system.

Example 14: A computing device includes memory; and one or more processors configured to: receive indications of hashed values of authentication factors associated with an entity; hash the hashed values of the authentication factors to generate double hashed values of the authentication factors; compare the double hashed values of the authentication factors with trusted authentication information that is encoded in entity credentials associated with the entity; and determine, based at least in part on comparing the double hashed values of the authentication factors with the trusted authentication information, whether the entity is a trusted entity.

Example 15: The computing device of example 14, wherein the trusted authentication information includes trusted values of the authentication factors encoded using two layers of hashing.

Example 16: The computing device of example 15, wherein each of the trusted values of the authentication factors in the trusted authentication information are encoded in the entity credentials by rounding, combining, and the two layers of hashing of a trusted value of the authentication factors.

Example 17: The computing device of example 16, wherein each of the hashed values of the authentication factors associated with the entity is a value of an authentication factor that has been rounded, combined, and hashed to generate a hashed value of the authentication factor.

Example 18: The computing device of example 14, wherein to determine whether the entity is a trusted entity, the one or more processors are further configured to: determine, based at least in part on comparing the hashed values of the authentication factors with trusted values of the trusted authentication information, an authentication value associated with the entity; and determine, based at least in part on the authentication value, whether the entity is a trusted entity.

Example 19: The computing device of example 18, wherein to determine whether the entity is a trusted entity, the one or more processors are further configured to: compare the authentication value to an authentication threshold associated with a secrecy level the computing device; and in response to determining that the authentication value exceeds the authentication threshold, determine that the entity is the trusted entity.

Example 20: A non-transitory computer readable storage medium storing instructions that, when executed by one or more processors of a computing device, cause one or more processors of a computing device to: receive indications of hashed values of authentication factors associated with an entity; hash the hashed values of the authentication factors to generate double hashed values of the authentication factors; compare the double hashed values of the authentication factors with trusted authentication information that is encoded in entity credentials associated with the entity; and determine, based at least in part on comparing the double hashed values of the authentication factors with the trusted authentication information, whether the entity is a trusted entity.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the embodiment, certain acts or events of any of the methods described herein can be performed in a different sequence, may be added, merged, or left out altogether (e.g., not all described acts or events are necessary for the practice of the method). Moreover, in certain embodiments, acts or events may be performed concurrently, e.g., through multi-threaded processing, interrupt processing, or multiple processors, rather than sequentially.

In some examples, a computer-readable storage medium may include a non-transitory medium. The term “non-transitory” indicates that the storage medium is not embodied in a carrier wave or a propagated signal. In certain examples, a non-transitory storage medium may store data that can, over time, change (e.g., in RAM or cache).

Various examples of the disclosure have been described. Any combination of the described systems, operations, or functions is contemplated. These and other examples are within the scope of the following claims.

What is claimed is:

1. A method comprising:
receiving, by one or more processors of a computing device, indications of values of authentication factors associated with an entity;
hashing, by the one or more processors, the values of the authentication factors to generate double hashed values of the authentication factors;
comparing, by the one or more processors, the double hashed values of the authentication factors with trusted authentication information that is encoded in entity credentials associated with the entity; and
determining, based on comparing the double hashed values of the authentication factors with the trusted authentication information, whether the entity is a trusted entity.

2. The method of claim 1, wherein the trusted authentication information includes trusted values of the authentication factors encoded using two layers of hashing.

3. The method of claim 2, wherein each of the trusted values of the authentication factors in the trusted authentication information are encoded in the entity credentials by rounding, combining, and the two layers of hashing of a trusted value of the authentication factors.

4. The method of claim 3, wherein each of the values of the authentication factors associated with the entity is a value of an authentication factor that has been rounded, combined, and hashed to generate a hashed value of the authentication factor.

5. The method of claim 1, wherein determining whether the entity is a trusted entity further comprises:
determining, by the one or more processors and based at least in part on comparing the values of the authentication factors with trusted values of the trusted authentication information, an authentication value associated with the entity; and
determining, by the one or more processors and based at least in part on the authentication value, whether the entity is a trusted entity.

6. The method of claim 5, wherein determining whether the entity is the trusted entity comprises:
comparing, by the one or more processors, the authentication value to an authentication threshold associated with a secrecy level the computing device; and
in response to determining that the authentication value exceeds the authentication threshold, determining, by the one or more processors, that the entity is the trusted entity.

7. The method of claim 5, wherein comparing the values of the authentication factors with the trusted values of the authentication information further comprises:
comparing, by the one or more processors, each value of an authentication factor with a trusted value of the authentication factor in the trusted authentication information to determine the authentication value associated with the entity.

8. The method of claim 5, wherein comparing the values of the authentication factors with the trusted values of the authentication information further comprises:
weighing, by the one or more processors, the authentication factors; and determining, by the one or more processors, the authentication value based at least in part on the weighing of the authentication factors.

9. The method of claim 1, wherein determining whether the entity is the trusted entity further comprises:
determining, by the one or more processors, that a plurality of techniques in the authentication factors meet a minimum reading quality and a minimum match quality;
determining, by the one or more processors and for each respective technique of the plurality of techniques, a weight based at least in part on a reading quality of the respective technique and a match quality of the respective technique; and
determining, by the one or more processors, whether the entity is the trusted entity based at least in part on the plurality of techniques in the authentication factors meet the minimum reading quality and the minimum match quality.

10. The method of claim 1, wherein the entity includes a person, and wherein the authentication factors include biometric information associated with the entity.

11. The method of claim 1, wherein the entity includes a device, and wherein the authentication factors include machine data produced by the device.

12. The method of claim 1, wherein a value of the authentication factors is indicative of a duress signal, and wherein determining whether the entity is the trusted entity further comprises:
determining that the value of the authentication factors indicates the duress signal; and
in response to determining that the value of the authentication factors indicates the duress signal, determining, by the one or more processors, that the entity is under duress.

13. The method of claim 1, wherein the computing device is part of a touchless authentication system.

14. A computing device comprising:
memory; and
one or more processors configured to:
receive indications of values of authentication factors associated with an entity;
hash the values of the authentication factors to generate double hashed values of the authentication factors;
compare the double hashed values of the authentication factors with trusted authentication information that is encoded in entity credentials associated with the entity; and
determine, based at least in part on comparing the double hashed values of the authentication factors with the trusted authentication information, whether the entity is a trusted entity.

15. The computing device of claim 14, wherein the trusted authentication information includes trusted values of the authentication factors encoded using two layers of hashing.

16. The computing device of claim 15, wherein each of the trusted values of the authentication factors in the trusted authentication information are encoded in the entity credentials by rounding, combining, and the two layers of hashing of a trusted value of the authentication factors.

17. The computing device of claim 16, wherein each of the values of the authentication factors associated with the entity is a value of an authentication factor that has been rounded, combined, and hashed to generate a hashed value of the authentication factor.

18. The computing device of claim 14, wherein to determine whether the entity is a trusted entity, the one or more processors are further configured to:
determine, based at least in part on comparing the values of the authentication factors with trusted values of the trusted authentication information, an authentication value associated with the entity; and
determine, based at least in part on the authentication value, whether the entity is a trusted entity.

19. The computing device of claim 18, wherein to determine whether the entity is a trusted entity, the one or more processors are further configured to:
compare the authentication value to an authentication threshold associated with a secrecy level the computing device; and
in response to determining that the authentication value exceeds the authentication threshold, determine that the entity is the trusted entity.

20. A non-transitory computer readable storage medium storing instructions that, when executed by one or more processors of a computing device, cause one or more processors of a computing device to:
receive indications of values of authentication factors associated with an entity;
hash the values of the authentication factors to generate double hashed values of the authentication factors;
compare the double hashed values of the authentication factors with trusted authentication information that is encoded in entity credentials associated with the entity; and
determine, based at least in part on comparing the double hashed values of the authentication factors with the trusted authentication information, whether the entity is a trusted entity.
